(19) United States
(12) Patent Application Publication
(10) Pub. No.: US 2024/0345301 A1
(43) Pub. Date: Oct. 17, 2024

(54) LAMINATE, OPTICAL ELEMENT, AND LIGHT GUIDE ELEMENT

(71) Applicant: FUJIFILM Corporation, Tokyo (JP)

(72) Inventors: Yuki FUKUSHIMA, Minamiashigara-shi (JP); Keisuke KODAMA, Minamiashigara-shi (JP); Shunya KATOH, Minamiashigara-shi (JP); Hideki KANEIWA, Minamiashigara-shi (JP)

(73) Assignee: FUJIFILM Corporation, Tokyo (JP)

(21) Appl. No.: 18/756,434

(22) Filed: Jun. 27, 2024

Related U.S. Application Data
(63) Continuation of application No. PCT/JP2022/046328, filed on Dec. 16, 2022.

(30) Foreign Application Priority Data
Dec. 28, 2021 (JP) 2021-214444

(51) Int. Cl. G02B 5/30; C09K 19/04; C09K 19/18; C09K 19/20; C09K 19/32; G02F 1/1335

(52) U.S. Cl. CPC G02B 5/3016; C09K 19/18; C09K 19/2028; C09K 19/322; G02F 1/133524; C09K 2019/0448; C09K 2019/181; C09K 2019/2035; C09K 2323/021

(57) ABSTRACT

A first object of the present invention is to provide a laminate having excellent light resistance. In addition, a second object of the present invention is to provide an optical element including the laminate and a light guide element.

A laminate of the present invention includes an optically anisotropic layer consisting of a cured layer of a composition containing a liquid crystal compound and a pair of oxygen barrier layers which are disposed on both sides of the optically anisotropic layer, in which the optically anisotropic layer has a liquid crystal alignment pattern in which an orientation of an optical axis derived from the liquid crystal compound is changed while continuously rotating along at least one in-plane direction, the composition contains a compound having a partial structure represented by Formula (I), the composition contains, as the liquid crystal compound, the compound having the partial structure represented by Formula (I), or the composition contains, as a compound which is not the liquid crystal compound, the compound having the partial structure represented by Formula (I), and an oxygen permeability coefficient of the oxygen barrier layer at 25° C. and 50% RH is 1.0×10⁻¹¹ cm³·cm/(cm²·s·mmHg) or less.

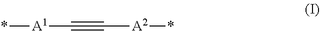

In Formula (I), A¹ and A² each independently represent an aromatic hydrocarbon ring group or an aromatic heterocyclic group, which may have a substituent. * represents a bonding position.

### CROSS-REFERENCE TO RELATED APPLICATIONS

This application is a Continuation of PCT International Application No. PCT/JP2022/046328 filed on Dec. 16, 2022, which claims priority under 35 U.S.C. § 119 (a) to Japanese Patent Application No. 2021-214444 filed on Dec. 28, 2021. The above applications are hereby expressly incorporated by reference, in their entirety, into the present application.

### BACKGROUND OF THE INVENTION

### 1. Field of the Invention

The present invention relates to a laminate, an optical element, and a light guide element.

### 2. Description of the Related Art

In recent years, since polarized light has been used in various optical devices or systems, there is a demand for an optical element for controlling reflection, focusing, and divergence of polarized light.

For example, WO2020/022496A discloses an optical element which includes an optically anisotropic layer consisting of a cured layer of a liquid crystalline composition containing a tolan compound as a liquid crystal compound and having a predetermined liquid crystal alignment pattern, as an optical element which has a large diffraction angle and from which diffracted light having a high diffraction efficiency is obtained.

### SUMMARY OF THE INVENTION

As a result of producing and examining the optical element described in WO2020/022496A, the present inventors have found that a liquid crystalline composition containing a tolan compound exhibits a high refractive index anisotropy Δn, and an optical element including an optically anisotropic layer consisting of a cured product of the liquid crystalline composition has a high diffraction efficiency, but on the other hand, the above-described optical characteristics are difficult to be maintained because of photodegradation of the tolan compound (in other words, the diffraction efficiency may be significantly reduced because of the photodegradation of the tolan compound). That is, it was clarified that there is room for improving the light resistance of the optical element.

An object of the present invention is to provide a laminate having excellent light resistance.

Another object of the present invention is to provide an optical element and a light guide element, each comprising the laminate.

In order to achieve the above objects, the inventors of the present invention carried out intensive examinations. As a result, the inventors have found that the objects can be achieved by the following constitution.

[1] A laminate comprising an optically anisotropic layer consisting of a cured layer of a composition containing a liquid crystal compound and a pair of oxygen barrier layers which are disposed on both sides of the optically anisotropic layer, in which the optically anisotropic layer has a liquid crystal alignment pattern in which an orientation of an optical axis derived from the liquid crystal compound is changed while continuously rotating along at least one in-plane direction, the composition contains a compound having a partial structure represented by Formula (I), the composition contains, as the liquid crystal compound, the compound having the partial structure represented by Formula (I), or the composition contains, as a compound which is not the liquid crystal compound, the compound having the partial structure represented by Formula (I), and an oxygen permeability coefficient of the oxygen barrier layer at 25° C. and 50% RH is 1.0×10⁻¹¹ cm³·cm/(cm²·s·mmHg) or less.

[2] The laminate according to [1], in which the composition contains, as the liquid crystal compound, the compound having the partial structure represented by Formula (I).

[3] The laminate according to [2], in which the compound having the partial structure represented by Formula (I) is a rod-like liquid crystal compound.

[4] The laminate according to [2] or [3], in which the compound having the partial structure represented by Formula (I) is a polymerizable liquid crystal compound.

[5] The laminate according to any one of [2] to [4], in which the composition contains only the compound having the partial structure represented by Formula (I) as the liquid crystal compound, or the composition further contains, as the liquid crystal compound, another liquid crystal compound having a structure different from a structure of the compound having the partial structure represented by Formula (I), and a content of the compound having the partial structure represented by Formula (I) is 50% by mass or more with respect to a total content of the compound having the partial structure represented by Formula (I) and the another liquid crystal compound.

[6] The laminate according to any one of [1] to [5], in which, in a case where the composition contains, as the liquid crystal compound, only the compound having the partial structure represented by Formula (I), a distance ΔHSP between a Hansen solubility parameter of a main component contained in the oxygen barrier layer and a Hansen solubility parameter of the compound having the partial structure represented by Formula (I), which is contained in the optically anisotropic layer, is larger than 3.5 MPa^{0.5}, and in a case where the composition contains, as the liquid crystal compound, the compound having the partial structure represented by Formula (I) and another liquid crystal compound having a structure different from a structure of the compound having the partial structure represented by Formula (I), a distance ΔHSP between the Hansen solubility parameter of the main component contained in the oxygen barrier layer and an average Hansen solubility parameter of the compound having the partial structure represented by Formula (I) and the another liquid crystal compound, which are contained in the optically anisotropic layer, is larger than 3.5 MPa^{0.5}.

[7] The laminate according to [6], in which at least one of the pair of oxygen barrier layers is disposed in direct contact with the optically anisotropic layer.

[8] The laminate according to [1], in which the composition contains, as the compound which is not the liquid crystal compound, the compound having the partial structure represented by Formula (I), and further contains another liquid crystal compound having a structure different from a structure of the compound having the partial structure represented by Formula (I).

[9] The laminate according to [8], in which a content of the compound having the partial structure represented by Formula (I) is 50% by mass or more with respect to a total content of the compound having the partial structure represented by Formula (I) and the other liquid crystal compound.

[10] The laminate according to [8] or [9], in which a distance ΔHSP between a Hansen solubility parameter of a main component contained in the oxygen barrier layer and an average Hansen solubility parameter of the compound having the partial structure represented by Formula (I) and the other liquid crystal compound, which are contained in the optically anisotropic layer, is larger than 3.5 MPa^{0.5}.

[11] The laminate according to [10], in which at least one of the pair of oxygen barrier layers is disposed in direct contact with the optically anisotropic layer.

[12] The laminate according to any one of [1] to [11], in which the compound having the partial structure represented by Formula (I) is a compound represented by Formula (II).

[13] The laminate according to [12], in which, in Formula (II), at least one of P¹ or P² is a polymerizable group.

[14] The laminate according to any one of [1] to [13], in which the compound having the partial structure represented by Formula (I) is a compound represented by Formula (III) or (IV).

[15] The laminate according to any one of [1] to [14], in which Δn of the composition at a wavelength of 550 nm is 0.21 or more.

[16] The laminate according to any one of [1] to [15], in which in both of the pair of oxygen barrier layers, a value obtained by dividing the oxygen permeability coefficient [cm³·cm/(cm²·s·mmHg)] at 25° C. and 50% RH by a film thickness [μm] is 1.0×10⁻¹³ or less.

[17] The laminate according to any one of [1] to [16], in which in both of the pair of oxygen barrier layers, a transmittance is 70% or more.

[18] The laminate according to any one of [1] to [17], in which one of the pair of oxygen barrier layers is glass and the other is not glass.

[19] The laminate according to any one of [1] to [18], further comprising a water vapor barrier layer having a water vapor permeability of 100 g/(m²·day) or less at 40° C. and 90% RH, in which the water vapor barrier layer is disposed at a side of the oxygen barrier layer opposite to the optically anisotropic layer.

[20] An optical element comprising the laminate according to any one of [1] to [19].

[21] A light guide element comprising the optical element according to [20], and a light guide plate.

According to the present invention, it is possible to provide a laminate having excellent light resistance.

In addition, according to the present invention, it is possible to provide an optical element and a light guide element, which include the laminate.

### BRIEF DESCRIPTION OF THE DRAWINGS

FIG. 1 is a schematic cross-sectional view showing an example of an embodiment of a laminate according to the present invention.

FIG. 2 is a schematic view of an optically anisotropic layer included in the laminate shown in FIG. 1.

FIG. 3 is a schematic plan view of an optically anisotropic layer included in the laminate shown in FIG. 1.

FIG. 4 is a conceptual diagram showing an action of the optically anisotropic layer shown in FIG. 2.

FIG. 5 is a conceptual diagram showing an action of the optically anisotropic layer shown in FIG. 2.

FIG. 6 is a schematic view showing another example of the optically anisotropic layer included in the laminate shown in FIG. 1.

FIG. 7 is a schematic view showing another example of the optically anisotropic layer included in the laminate shown in FIG. 1.

### DESCRIPTION OF THE PREFERRED EMBODIMENTS

Hereinafter, the present invention will be described in detail.

Although the configuration requirements to be described below may be described based on representative embodiments of the present invention, the present invention is not limited to such embodiments.

In each of the drawings, for easy visual recognition, the reduced scale of components is different from the actual scale.

In addition, in this specification, a numerical range represented using “to” means a range that includes numerical values written before and after “to” as a lower limit and an upper limit.

In addition, in the present specification, “perpendicular” or “parallel” regarding an angle represents a range of the exact angle±10°.

In addition, in the present specification, Re (λ) represents an in-plane retardation at a wavelength 2. Unless otherwise specified, the wavelength λ is 550 nm.

In addition, in this specification, Re (λ) is a value measured at the wavelength λ using AxoScan (manufactured by Axometrics, Inc.). By inputting an average refractive index ((nx+ny+nz)/3) and a film thickness (d (μm)) to AxoScan, the following expressions can be calculated.

Slow Axis Direction(°):Re(λ)=R0(λ)

Although R0 (λ) is displayed as a numerical value calculated by AxoScan, it means Re (λ).

In addition, in the present specification, “(meth)acryloyloxy group” is a notation representing both an acryloyloxy group and a methacryloyloxy group, and “(meth)acrylate” is a notation representing both an acrylate and a methacrylate.

In addition, in a notation for a group (atomic group) in the present specification, in a case where the group is denoted without specifying whether it is substituted or unsubstituted, the group includes both a group having no substituent and a group having a substituent. For example, an “alkyl group” includes not only an alkyl group having no substituent (unsubstituted alkyl group), but also an alkyl group having a substituent (substituted alkyl group).

In addition, in the present specification, in a case where a “substituent” is simply described, examples of the substituent include the following substituent L.

### (Substituent L)

Examples of the substituent L include an alkyl group having 1 to 10 carbon atoms, an alkoxy group having 1 to 10 carbon atoms, an alkylamino group having 1 to 10 carbon atoms, an alkylthio group having 1 to 10 carbon atoms, an alkanoyl group having 1 to 10 carbon atoms, an alkanoyloxy group having 1 to 10 carbon atoms, an alkanoylamino group having 1 to 10 carbon atoms, an alkanoylthio group having 1 to 10 carbon atoms, an alkyloxycarbonyl group having 2 to 10 carbon atoms, an alkylaminocarbonyl group having 2 to 10 carbon atoms, an alkylthiocarbonyl group having 2 to 10 carbon atoms, a hydroxy group, an amino group, a mercapto group, a carboxy group, a sulfo group, an amido group, a cyano group, a nitro group, a halogen atom, a polymerizable group, and the like. Provided that, in a case where the group described as the substituent L contains —CH₂— (methylene group), a group in which at least one —CH₂— contained in the group is substituted with —O—, —CO—, —CH═CH—, or —C═C— is also included in the substituent L. For example, in a case where the above-described group has two or more —CH₂—'s, one —CH₂— may be substituted with —O— and one —CH₂— adjacent to the —O— may be substituted with —CO— to form an ester group (—O—CO—). Here, in a case where the group described as the substituent L has a hydrogen atom, a group in which at least one hydrogen atom -in the group is substituted with at least one selected from the group consisting of a fluorine atom and a polymerizable group is also included in the substituent L.

Examples of the above-described polymerizable group include an ethylenically unsaturated group, a ring-polymerizable group, and the like, and among these, a substituent selected from a polymerizable group P, which will be described later, is preferable.

Among these, the substituent Lis preferably an alkyl group having 1 to 10 carbon atoms, an alkoxy group having 1 to 10 carbon atoms, an alkanoyl group having 1 to 10 carbon atoms, an alkanoyloxy group having 1 to 10 carbon atoms, an alkyloxycarbonyl group having 2 to 10 carbon atoms, a trifluoromethyl group, a hydroxy group, a carboxy group, a cyano group, a nitro group, or a halogen atom, more preferably an alkyl group having 1 to 10 carbon atoms, an alkoxy group having 1 to 10 carbon atoms, an alkanoyl group having 2 to 10 carbon atoms, an alkanoyloxy group having 2 to 10 carbon atoms, an alkyloxycarbonyl group having 2 to 10 carbon atoms, a trifluoromethyl group, or a halogen atom, and still more preferably an alkyl group having 1 to 6 carbon atoms, an alkoxy group having 1 to 6 carbon atoms, an alkanoyl group having 2 to 6 carbon atoms, an alkanoyloxy group having 2 to 6 carbon atoms, an alkyloxycarbonyl group having 2 to 6 carbon atoms, a trifluoromethyl group, or a fluorine atom.

In addition, in the present specification, in a case of simply referring to a “polymerizable group”, examples of the polymerizable group include the following polymerizable group P.

(Polymerizable group P)

Examples of the polymerizable group P include a group represented by any one of Formulae (P-1) to (P-19) below. In the following formulae, * represents a bonding position, Me represents a methyl group, and Et represents an ethyl group. Among these, Formula (P-1) or Formula (P-2) (a(meth)acryloyloxy group) is preferable.

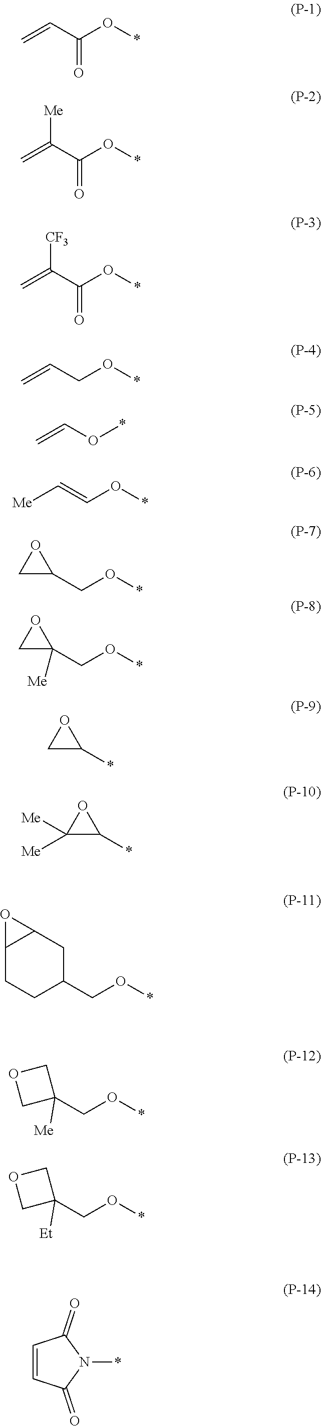

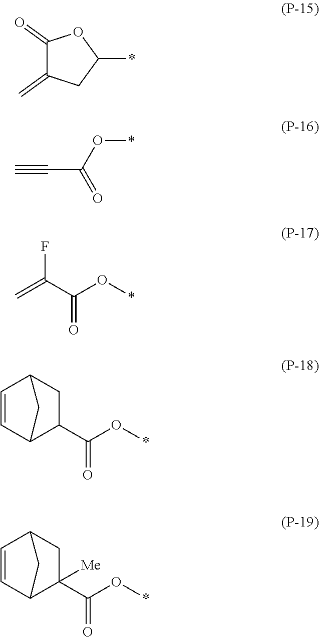

In addition, in the present specification, a “solid content” of a composition refers to components which form a composition layer formed of the composition, and in a case where the composition includes a solvent (an organic solvent, water, and the like), the solid content means all components except the solvent. In addition, in a case where the components are components which form a composition layer, the components are considered to be solid contents even in a case where the components are liquid components.

In addition, in the present specification, unless otherwise specified, a thickness of a layer is an average value of the thicknesses obtained by observing a cross section cut by a microtome with a scanning electron microscope (SEM) or a transmission electron microscope (TEM) and measuring the thickness at 10 points.

### [Laminate]

The laminate according to the embodiment of the present invention is a laminate having an optically anisotropic layer consisting of a cured layer of a composition containing a liquid crystal compound and a pair of oxygen barrier layers which are disposed on both sides of the optically anisotropic layer, in which the optically anisotropic layer has a liquid crystal alignment pattern in which an orientation of an optical axis derived from the liquid crystal compound is changed while continuously rotating along at least one in-plane direction, the composition contains a compound (hereinafter, referred to as a “specific tolan compound”) having a partial structure represented by Formula (I) described later, the composition contains, as the liquid crystal compound, the above-described specific tolan compound, or the composition contains, as a compound which is not the liquid crystal compound, the above-described specific tolan compound, and an oxygen permeability coefficient of the oxygen barrier layer at 25° C. and 50% RH is 1.0×10⁻¹¹ cm³·cm/(cm²·s·mmHg) or less.

The case where the composition contains the above-described specific tolan compound as the liquid crystal compound corresponds to a case where the liquid crystalline composition is a liquid crystalline composition of any one of the first aspect or the second aspect, which will be described later. In addition, a case where the composition contains, as a compound which is not a liquid crystal compound, the above-described specific tolan compound corresponds to a case where the liquid crystalline composition is a liquid crystalline composition of a third aspect, which will be described later.

The laminate of the above-described configuration according to the embodiment of the present invention contains an optically anisotropic layer consisting of a cured product of a liquid crystalline composition containing a tolan compound, and thus has high diffraction efficiency, and photodegradation is suppressed, thereby the high diffraction efficiency can be maintained for a long period of time (in other words, light resistance is excellent).

A reason therefor is not clear in detail, but is presumed as follows by the present inventors.

Recently, the present inventors have found that, in the optically anisotropic layer consisting of a cured product of a liquid crystalline composition containing a tolan compound, the diffraction efficiency is reduced by photodegradation (for example, oxidation, radical decomposition, and the like) of the tolan compound caused by singlet oxygen generated by light irradiation. The laminate according to the embodiment of the present invention includes an oxygen barrier layer having a predetermined oxygen permeability coefficient on both surfaces of the optically anisotropic layer. Therefore, it is considered that, in the periphery of the optically anisotropic layer, the generation of singlet oxygen, which is a cause of photodegradation of the tolan compound, is suppressed, and as a result, the light resistance is excellent.

In addition, as will be described later, it has been found that, in the laminate according to the embodiment of the present invention, in a case where at least one of the oxygen barrier layers disposed on both sides of the optically anisotropic layer is disposed to be in direct contact with the optically anisotropic layer, the light resistance of the laminate can be further improved.

In addition, as will be described later, it has been found that, in the laminate according to the embodiment of the present invention, by increasing a distance ΔHSP between a Hansen solubility parameter (HSP value) of a main component of the above-described oxygen barrier layer and an average HSP value of the specific tolan compound and the other liquid crystal compound, which are contained in the liquid crystalline composition forming the optically anisotropic layer, movement of the specific tolan compound and the other liquid crystal compound (particularly, the specific tolan compound and the other liquid crystal compound, which are not immobilized by polymerization) in the optically anisotropic layer to the oxygen barrier layer is suppressed, and as a result, the light resistance of the laminate can be further improved, and the like.

Hereinafter, there is a case where the more excellent light resistance of the laminate and/or the more excellent durability (moisture-heat resistance) of the laminate may be referred to the “more excellent effect of the present invention”.

Hereinafter, specific embodiments of the laminate according to the embodiment of the present invention will be described as an example, and each member will be described in detail. The configuration of the laminate according to the embodiment of the present invention is not limited thereto.

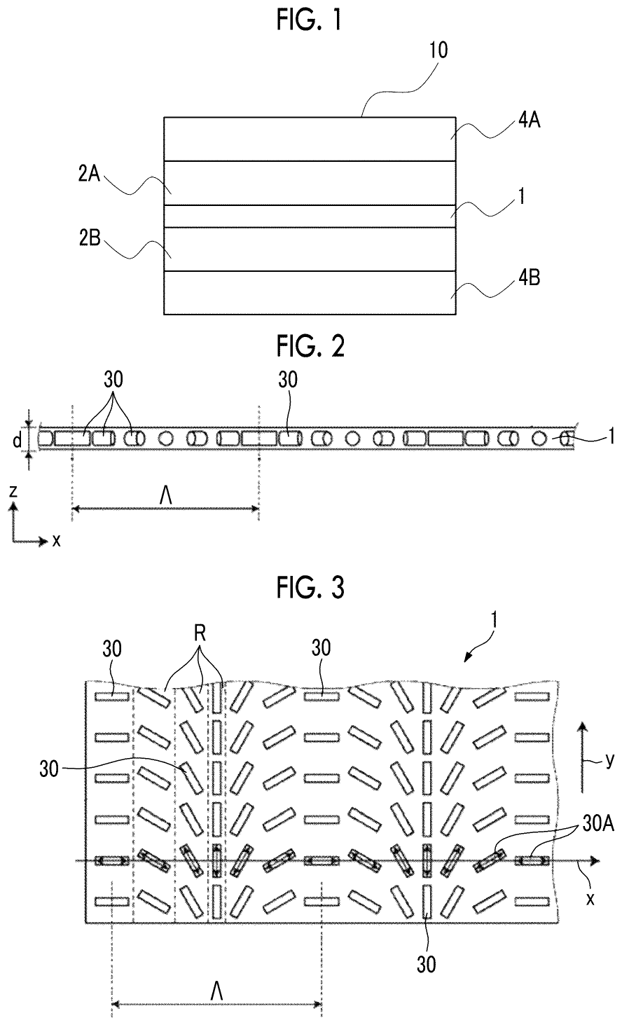

FIG. 1 is a schematic cross-sectional view showing an example of a laminate according to the embodiment of the present invention.

The laminate 10 has an optically anisotropic layer 1, a pair of oxygen barrier layers 2A and 2B disposed on both sides of the optically anisotropic layer 1 (both sides of the main surface of the optically anisotropic layer), a water vapor barrier layer 4A disposed on the oxygen barrier layer 2A at a side opposite to the optically anisotropic layer 1, and a water vapor barrier layer 4B disposed on the oxygen barrier layer 2B at a side opposite to the optically anisotropic layer 1.

In addition, the oxygen permeability coefficient of each oxygen barrier layer of the oxygen barrier layer 2A and the oxygen barrier layer 2B at 25° C. and 50% RH is 1.0×10⁻¹¹ cm³·cm/(cm²·s·mmHg) or less.

In addition, the optically anisotropic layer 1 is an optically anisotropic layer consisting of a cured layer of a composition containing a liquid crystal compound, and has a liquid crystal alignment pattern in which an orientation of an optical axis derived from the liquid crystal compound is changed while continuously rotating along at least one in-plane direction.

In the laminate 10, the optically anisotropic layer 1 is in direct contact with the oxygen barrier layer 2A and the optically anisotropic layer 1 is in direct contact with the oxygen barrier layer 2B, without interposing other layers. An interlayer such as an alignment film, a pressure sensitive adhesive layer, and an adhesive layer may be interposed between the optically anisotropic layer 1 and at least one of the oxygen barrier layer 2A or 2B. The alignment film may be an alignment film used for the purpose of forming the liquid crystal compound in a predetermined alignment pattern in the production of the optically anisotropic layer 1, which will be described later.

Among these, from the viewpoint of the more excellent effect of the present invention, it is preferable that the optically anisotropic layer 1 is directly in contact with the oxygen barrier layer 2A and the optically anisotropic layer 1 is in direct contact with the oxygen barrier layer 2B, without interposing other layers.

Furthermore, in the laminate 10, the water vapor barrier layer 4A is disposed at a side opposite to the optically anisotropic layer 1 of the oxygen barrier layer 2A, and the water vapor barrier layer 4B is disposed at a side opposite to the optically anisotropic layer 1 of the oxygen barrier layer 2B, but the water vapor barrier layers 4A and 4B may not be disposed. In addition, an aspect may be adopted in which only any one of the water vapor barrier layer 4A or 4B is disposed.

Hereinafter, each member of the laminate 10 will be described.

### <<Optically Anisotropic Layer>>

The optically anisotropic layer 1 is an optically anisotropic layer consisting of a cured layer of a composition containing a liquid crystal compound.

FIGS. 2 and 3 are schematic cross-sectional views of the optically anisotropic layer 1. FIG. 2 is a schematic side view showing the optically anisotropic layer 1, and FIG. 3 is a schematic plan view showing a liquid crystal alignment pattern of the optically anisotropic layer 1 shown in FIG. 2. In the drawings, a sheet surface of the sheet-like optically anisotropic layer 1 is defined as an xy plane, and a thickness direction is defined as a z direction.

The optically anisotropic layer 1 shown in FIG. 2 consists of a cured layer of a composition containing a liquid crystal compound.

The optically anisotropic layer 1 has a liquid crystal alignment pattern (length A of one period) in which an orientation of an optical axis derived from the liquid crystal compound 30 is changed while continuously rotating along at least one in-plane direction.

In FIGS. 2 to 5, only the liquid crystal molecules present on one main surface side of the optically anisotropic layer 1 are shown in order to simplify the drawings and clearly show the configuration of the optically anisotropic layer 1. However, the optically anisotropic layer 1 has a structure in which the aligned liquid crystal compounds 30 are laminated same as in an optically anisotropic layer which is formed using a composition including a normal liquid crystal compound.

Typically, in a case where a value of an in-plane retardation is set as 2/2, the optically anisotropic layer 1 has a function as a general λ/2 plate, that is, a function of imparting a phase difference of a half wavelength, that is, 180° to two linearly polarized light components which are included in light incident into the optically-anisotropic layer and are perpendicular to each other.

As shown in FIG. 3, in a plane of the optically anisotropic layer 1, the optically anisotropic layer 1 has a liquid crystal alignment pattern in which one orientation of an optical axis 30A (hereinafter, may be also referred to as “optical axis 30A”) derived from the liquid crystal compound 30 is changed while continuously rotating in one direction. Here, the one direction in which the optical axis 30A is changed while rotating is set coincidental with a direction of an x-axis in the xy plane. Hereinafter, the one direction in which the optical axis 30A is changed while rotating will be described as an x direction.

The optical axis 30A derived from the liquid crystal compound 30 is an axis having the highest refractive index in the liquid crystal compound 30, that is, a so-called slow axis. As shown in FIG. 2, in a case where the liquid crystal compound 30 is a rod-like liquid crystal compound, the optical axis 30A is along a rod-shaped major axis direction.

Specifically, changing the orientation of the optical axis 30A while continuously rotating along the x direction means that an angle between the optical axis 30A of the liquid crystal compound 30, which is arranged along the x direction, and the x direction varies depending on positions in the x direction, and the angle between the optical axis 30A and the x direction is gradually changed from θ to θ+180° or θ−180° in the x direction. Here, the expression “the angle gradually is changed” means that the angle may be changed at constant angular intervals, or may be changed continuously. However, a difference between the angles of the optical axes 30A of the liquid crystal compound 30 adjacent to each other in the x direction is preferably 45° or less, more preferably 15° or less, and still more preferably less than 15°.

On the other hand, regarding the liquid crystal compound 30 forming the optically anisotropic layer 1, the liquid crystal compounds 30 having the same orientation of the optical axes 30A are arranged at regular intervals in a y direction perpendicular to the x direction in a plane, that is, a y direction perpendicular to the one direction (x direction) in which the optical axis 30A continuously rotates. In other words, regarding the liquid crystal compound 30 forming the optically anisotropic layer 1, in the liquid crystal compounds 30 arranged in the y direction, angles between the orientation of the optical axis 30A and the x direction are the same. In the optically anisotropic layer 1, in such a liquid crystal alignment pattern of the liquid crystal compound 30, the length (distance) over which the optical axis 30A of the liquid crystal compound 30 rotates by 180° in the x direction along which the orientation of the optical axis 30A is changed while continuously rotating in the plane is defined as a length A of the single period in the liquid crystal alignment pattern. In other words, the length of the single period in the liquid crystal alignment pattern is defined as the distance between θ and θ+180° that is a range of the angle between the optical axis 30A of the liquid crystal compound 30 and the x direction. Specifically, as shown in FIG. 3, a distance of centers in the x direction of two liquid crystal compounds 30 in which the x direction and the direction of the optical axis 30A match each other is defined as the length A of the single period (hereinafter, may be also referred to as “one period Λ” or “period Λ”). The liquid crystal alignment pattern of the optically anisotropic layer 1 is a pattern in which the liquid crystal alignment of this single period Λ is repeated in the x direction.

As described above, in the optically anisotropic layer 1, in the liquid crystal compounds 30 arranged in the y direction, the angles between the optical axes 30A thereof and the x direction in which the orientation of the optical axis of the liquid crystal compound 30 rotates are the same. Regions where the liquid crystal compounds 30 in which the angles between the optical axes 30A and the x direction are the same are arranged in the y direction will be referred to as “regions R”.

In this case, a value of the in-plane retardation (Re) in each region R is a half wavelength of light (hereinafter, referred to as a “target light”) to be diffracted by the optically anisotropic layer, that is, in a case where a wavelength of the target light is λ, the in-plane retardation Re is preferably λ/2. The in-plane retardation is calculated from the product of a refractive index anisotropy Δn of the regions R and the thickness (film thickness) d of the optically anisotropic layer. Here, the difference in refractive index generated by refractive index anisotropy of the region R in the optically anisotropic layer is defined by a difference between a refractive index of a direction of an in-plane slow axis of the region R and a refractive index of a direction orthogonal to the direction of the slow axis. That is, the difference Δn in refractive index generated by refractive index anisotropy of the region R is the same as a difference between a refractive index of the liquid crystal compound 30 in the direction of the optical axis 30A and a refractive index of the liquid crystal compound 30 in a direction perpendicular to the optical axis 30A in a plane of the region R. That is, the above-described difference Δn in refractive index depends on the liquid crystal compound, and the in-plane retardation of each region R is substantially the same. However, as described above, each region R has a different direction of the optical axis 30A.

In the optically anisotropic layer 1, since the orientation of the optical axis 30A rotates in the plane, it is difficult to measure the in-plane retardation as a whole. However, the in-plane retardation of the optically anisotropic layer 1 can be estimated from the period and the diffraction efficiency.

In a case where circularly polarized light is incident into such an optically anisotropic layer 1, the light is refracted such that the direction of the circularly polarized light is converted.

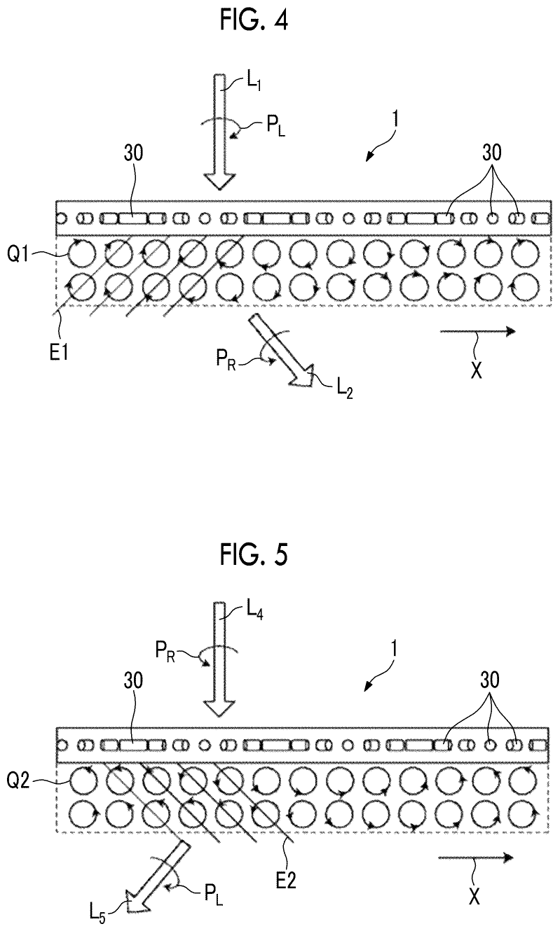

This action is conceptually shown in FIG. 4 using the optically anisotropic layer 1 as an example. It is assumed that the in-plane retardation of the optically anisotropic layer 1 is λ/2.

In this case, as shown in FIG. 4, in a case where an incidence light L₁ as levorotatory circularly polarized light P_{L} is incident into the optically anisotropic layer 1, the incidence light L₁ transmits through the optically anisotropic layer 1 to be given a phase difference of 180°, thereby a transmitted light L₂ is converted into dextrorotatory circularly polarized light P_{R}.

In addition, in a case where the incidence light L₁ transmits through the optically anisotropic layer 1, an absolute phase thereof changes depending on the orientation of the optical axis 30A of each of the liquid crystal compounds 30. At this time, since the orientation of the optical axis 30A changes while rotating in the x direction, the amount of change in absolute phase of the incidence light L₁ varies depending on the orientation of the optical axis 30A. Furthermore, the liquid crystal alignment pattern formed in the optically anisotropic layer 1 is a pattern which is periodic in the x direction. Therefore, as shown in FIG. 4, the incidence light L₁ transmitted through the optically anisotropic layer 1 is imparted with an absolute phase Q1 which is periodic in the x direction corresponding to the orientation of each optical axis 30A. As a result, an equiphase surface E1 which is tilted in a direction opposite to the x direction is formed.

Therefore, the transmitted light L₂ is refracted to be tilted in a direction perpendicular to the equiphase surface E1 and travels in a direction different from a traveling direction of the incidence light L₁. In this way, the incidence light L₁ of the levorotatory circularly polarized light P_{L} is converted into the transmitted light L₂ of the dextrorotatory circularly polarized light P_{R} which is tilted by a predetermined angle in the x direction with respect to an incidence direction.

On the other hand, as conceptually shown in FIG. 5, in a case where an incidence light L₄ of dextrorotatory circularly polarized light P_{R} is incident into the optically anisotropic layer 1 having the same in-plane retardation, the incidence light L₄ transmits through the optically anisotropic layer 1 to be given a phase difference of 180°, thereby the incidence light L₄ is converted into a transmitted light L₅ of levorotatory circularly polarized light P_{L}.

In addition, in a case where the incidence light L_{L} transmits through the optically anisotropic layer 1, an absolute phase thereof changes depending on the orientation of the optical axis 30A of each of the liquid crystal compounds 30. At this time, since the orientation of the optical axis 30A changes while rotating in the x direction, the amount of change in absolute phase of the incidence light L₄ varies depending on the orientation of the optical axis 30A. Furthermore, the liquid crystal alignment pattern formed in the optically anisotropic layer 1 is a pattern which is periodic in the x direction. Therefore, as shown in FIG. 5, the incidence light L₄ transmitted through the optically anisotropic layer 1 is imparted with an absolute phase Q2 which is periodic in the x direction corresponding to the orientation of each optical axis 30A.

Here, the incidence light L₄ is dextrorotatory circularly polarized light P_{R}. Therefore, the absolute phase Q2 which is periodic in the x direction corresponding to the orientation of the optical axis 30A is opposite to the incidence light L₁ as levorotatory circularly polarized light P_{L}. As a result, in the incidence light L₄, an equiphase surface E2 which is tilted in the x direction opposite to that of the incidence light L₁ is formed.

Therefore, the incidence light L₄ is refracted to be tilted in a direction perpendicular to the equiphase surface E2 and travels in a direction different from a traveling direction of the incidence light L₄. In this way, the incidence light L₄ is converted into the transmitted light L₅ of levorotatory circularly polarized light which is tilted by a predetermined angle in a direction opposite to the x direction with respect to an incidence direction.

As described above, in the optically anisotropic layer 1, the value of the in-plane retardation is preferably half the wavelength of the target light. This is because that, as the value of the in-plane retardation is closer to the half wavelength of the target light, high diffraction efficiency can be obtained in the diffraction of the target light. The in-plane retardation Re (λ)=Δn_{λ}×d of the optically anisotropic layer with respect to incidence light having a wavelength in the x direction of A nm is preferably within a range defined by the following expression and can be appropriately set.

0.7×(λ/2)nm≤Δn_{λ}×d≤1.3×(λ/2)nm

Here, by changing the single period Λ of the liquid crystal alignment pattern formed in the optically anisotropic layer 1, refraction angles of the transmitted light components L₂ and L₅ can be adjusted. Specifically, as the single period Λ of the liquid crystal alignment pattern decreases, light components transmitted through the liquid crystal compounds 30 adjacent to each other more strongly interfere with each other. Therefore, the transmitted light components L₂ and L₅ can be more largely refracted. Furthermore, by reversing a rotation direction of the optical axis 30A of the liquid crystal compound 30 which rotates in the x direction, a refraction direction of the transmitted light can be reversed. The period Λ is preferably 50 μm or less, more preferably 25 μm or less, and still more preferably 5 μm or less.

It is sufficient that the film thickness d of the optically-anisotropic layer 1 is appropriately set in order to obtain a desired in-plane retardation, but the film thickness d is preferably 1 μm or less, more preferably 0.8 μm or less, and still more preferably 0.5 μm or less. In particular, in a case where the laminate is used as a birefringent mask for forming a photo-alignment pattern, a smaller film thickness d is preferable. As the film thickness d is smaller, a formation accuracy of the photo-alignment pattern can be improved.

The ratio Λ/d of the period Λ to the film thickness d of the optically-anisotropic layer is preferably 1 or more.

The period Λ of the liquid crystal alignment pattern in the optically-anisotropic layer 1 is obtained from a period of light and dark by observing bright and dark period pattern of bright portions and dark portions with a polarizing microscope under a condition of crossed nicols. Twice the period of the observed bright and dark period pattern corresponds to the period Λ of the liquid crystal alignment pattern.

In addition, the film thickness d of the optically-anisotropic layer 1 can be measured by, for example, observing a cross section of the optically-anisotropic layer with a scanning electron microscope.

In the optically anisotropic layer 1, the refractive index anisotropy Δn at a wavelength of 550 nm is preferably 0.21 or more. The upper limit is not particularly limited, and is preferably 0.80 or less.

<Composition (liquid crystalline composition)>

As described above, the optically anisotropic layer 1 consists of a cured layer of a composition (liquid crystalline composition) containing a liquid crystal compound. Hereinafter, the liquid crystalline composition for forming the optically anisotropic layer 1 will be described in detail.

### (Specific Aspect of Liquid Crystalline Composition)

First, specific examples of the liquid crystalline composition include the following aspects.
First aspect: the liquid crystalline composition contains, as the liquid crystal compound, only the specific tolan compound.
Second aspect: the liquid crystalline composition contains, as the liquid crystal compound, the specific tolan compound and a liquid crystal compound having a structure different from that of the specific tolan compound (hereinafter, also referred to as “other liquid crystal compounds”).
Third aspect: the liquid crystalline composition contains, as the non-liquid crystal compound, a specific tolan compound and contains, as the liquid crystal compound, a liquid crystal compound having a structure different from that of the specific tolan compound (other liquid crystal compounds).

In the second aspect and the third aspect, the liquid crystal compound having a structure different from that of the specific tolan compound (other liquid crystal compounds) means a liquid crystal compound not including the partial structure represented by Formula (I) described above.

In addition, the liquid crystalline composition of the first aspect does not include the other liquid crystal compound having a structure different from that of the specific tolan compound.

In addition, in the following description, among the specific tolan compounds, a specific tolan compound exhibiting liquid crystallinity is referred to as a “liquid crystalline specific tolan compound”, and a specific tolan compound not exhibiting liquid crystallinity is referred to as a “non-liquid crystalline specific tolan compound”. That is, the above-described liquid crystalline composition according to the first aspect contains, as the liquid crystal compound, only the liquid crystalline specific tolan compound. In addition, the above-described liquid crystalline composition according to the second aspect contains the liquid crystalline specific tolan compound and the other liquid crystal compound. Furthermore, the above-described liquid crystalline composition of the third aspect contains a non-liquid crystalline specific tolan compound and another liquid crystal compound.

Hereinafter, each component in the liquid crystalline composition will be described. The liquid crystalline composition may further contain various components such as a polymerization initiator described later, in addition to the liquid crystal compound.

(Specific tolan compound) The liquid crystalline composition contains a compound (specific tolan compound) having a partial structure represented by Formula (I).

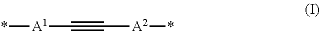

In Formula (I), A¹ and A² each independently represent an aromatic hydrocarbon ring group or an aromatic heterocyclic group, which may have a substituent. * represents a bonding position.

The aromatic hydrocarbon ring group may be a monocyclic structure or a polycyclic structure.

The aromatic hydrocarbon ring group is not particularly limited, but is preferably an arylene group, more preferably an arylene group having 6 to 20 carbon atoms, still more preferably an arylene group having 6 to 10 carbon atoms, and particularly preferably a phenylene group or a naphthylene group.

The aromatic heterocyclic group may be a monocyclic structure or a polycyclic structure. Among these, the aromatic heterocyclic group is preferably a 5-membered or 6-membered monocyclic aromatic heterocyclic group. A heteroatom contained in the aromatic heterocyclic group is not particularly limited, and examples thereof include an oxygen atom, a nitrogen atom, and a sulfur atom.

The aromatic heterocyclic group is not particularly limited, but is preferably a heteroarylene group, more preferably a heteroarylene group having 3 to 20 carbon atoms, and still more preferably a heteroarylene group having 3 to 10 carbon atoms. The heteroatom contained in the heteroarylene group is preferably at least one selected from the group consisting of a nitrogen atom, an oxygen atom, and a sulfur atom.

The substituent which may be contained in the above-described aromatic hydrocarbon ring group and aromatic heterocyclic group is not particularly limited, but is preferably a substituent selected from the above-described substituent L.

The specific tolan compound may or may not exhibit liquid crystallinity.

In general, the liquid crystal compound can be classified into a rod-like type and a disk-like type according to the shape thereof. Furthermore, the above-described types of compounds respectively include a low-molecular-weight type compound and a polymer type compound. The term, polymer, generally refers to a molecule having a polymerization degree of 100 or more (Masao Doi, Polymer Physics-Phase Transition Dynamics, page 2, Iwanami Shoten, Publishers, 1992). In a case where the specific tolan compound exhibits liquid crystallinity, the liquid crystalline specific tolan compound may be any of the above-described compounds, but among these, a rod-like liquid crystal compound is preferable.

In addition, in a case where the specific tolan compound exhibits liquid crystallinity, the liquid crystalline specific tolan compound is also preferably a liquid crystal compound having a polymerizable group in the molecule (hereinafter, also referred to as “polymerizable liquid crystal compound”).

Examples of the polymerizable group include an ethylenically unsaturated group and a ring-polymerizable group, and specific examples thereof include a vinyl group, a styryl group, an allyl group, and a substituent selected from the above-described polymerizable group P. In a case where the liquid crystalline specific tolan compound has a polymerizable group, it is preferable that the liquid crystalline specific tolan compound has two or more polymerizable groups in one molecule from the viewpoint of immobilizing the alignment.

The molecular weight of the specific tolan compound is, for example, preferably 200 to 100,000, more preferably 300 to 10,000, and still more preferably 400 to 2,500. In a case where the specific tolan compound is a polymer, the above-described molecular weight means a weight-average molecular weight.

From the viewpoint of more excellent effect of the present invention, the specific tolan compound is preferably a compound represented by Formula (II), and more preferably a compound represented by Formula (III) or Formula (IV).

Hereinafter, the compounds represented by Formulae (II) to (IV) will be described.

(Compound represented by Formula (II))

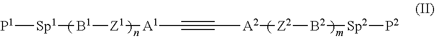

In Formula (II), P¹ and P² each independently represent a hydrogen atom, a halogen atom, —CN, —NCS, or a polymerizable group.

P¹ and P² are each independently preferably a polymerizable group. The polymerizable group is not particularly limited, and examples thereof include an ethylenically unsaturated group, a ring-polymerizable group, and the like, but is preferably a substituent selected from the above-described polymerizable group P.

In Formula (II), Sp¹ and Sp² each independently represent a single bond or a divalent linking group. Provided that Sp¹ and Sp² do not represent a divalent linking group including at least one group selected from the group consisting of an aromatic hydrocarbon ring group, an aromatic heterocyclic group, and an aliphatic hydrocarbon ring group.

The divalent linking group represented by Sp¹ and Sp² is not particularly limited, but is preferably an alkylene group (preferably an alkylene group having 1 to 20 carbon atoms), an alkenylene group (preferably an alkenylene group having 2 to 20 carbon atoms), —O—, —S—, —CO—, —SO—, —SO₂—, —COO—, —OCO—, —CO—S—, —S—CO—, —O—CO—O—, or a divalent linking group obtained by combining a plurality of these.

Among these, Sp¹ and Sp² are each independently preferably a single bond or an alkylene group having 1 to 10 carbon atoms, —O—, —S—, —CO—, —COO—, —OCO—, or a divalent linking group obtained by combining a plurality of these, more preferably a single bond or an alkylene group having 1 to 6 carbon atoms, —O—, —S—, or a divalent linking group obtained by combining a plurality of these, and still more preferably a single bond or an alkylene group having 1 to 4 carbon atoms, —O—, —S—, or a divalent linking group obtained by combining a plurality of these.

In Formula (II), Z¹ and Z² each independently represent a single bond or a divalent linking group. In a case where there are a plurality of Z¹'s and a plurality of Z²'s, the plurality of Z¹'s may be the same as or different from each other and the plurality of Z²'s may be the same as or different from each other. Provided that Z¹ and Z² do not represent a divalent linking group including at least one group selected from the group consisting of an aromatic hydrocarbon group, an aromatic heterocyclic ring group, and an aliphatic hydrocarbon ring group.

The divalent linking group represented by Z¹ and Z² is not particularly limited, but is preferably an alkylene group (preferably an alkylene group having 1 to 20 carbon atoms), an alkenylene group (preferably an alkenylene group having 2 to 20 carbon atoms), an alkynylene group (preferably an alkynylene group having 2 to 20 carbon atoms), —O—, —S—, —CO—, —SO—, —SO₂—, —COO—, —OCO—, —CO—S—, —S—CO—, —O—CO—O—, or a divalent linking group obtained by combining a plurality of these.

More specific examples of the divalent linking group represented by Z¹ and Z² include —O—, —S—, —CHRCHR—, —OCHR—, —CHRO—, —CO—, —SO—, —SO₂—, —COO—, —OCO—, —CO—S—, —S—CO—, —O—CO—O—, —CO—NR—, —NR—CO—, —SCHR—, —CHRS—, —SO—CHR—, —CHR—SO—, —SO₂—CHR—, —CHR—SO₂—, —CF₂O—, —OCF₂—, —CF₂S—, —SCF₂—, —OCHRCHRO—, —SCHRCHRS—, —SO—CHRCHR—SO—, —SO₂—CHRCHR—SO₂—, —CH═CH—COO—, —CH═CH—OCO—, —COO—CH═CH—, —OCO—CH═CH—, —COO—CHRCHR—, —OCO—CHRCHR—, —CHRCHR—COO—, —CHRCHR—OCO—, —COO—CHR—, —OCO—CHR—, —CHR—COO—, —CHR—OCO—, —CR═CR—, —CR═N—, —N═CR—, —N═N—, —CR═N—N═CR—, —CF—CF—, and —C═C—.

R represents a hydrogen atom or an alkyl group having 1 to 10 carbon atoms. R is preferably a hydrogen atom or an alkyl group having 1 to 6 carbon atoms, more preferably a hydrogen atom or an alkyl group having 1 to 4 carbon atoms, and still more preferably a hydrogen atom. In a case where a plurality of R's are present, the plurality of R's may be the same as or different from each other.

Among these, Z¹ and Z² are each independently preferably —CHRCHR—, —OCHR—, —CHRO—, —COO—, —OCO—, —CO—NH—, —NH—CO—, or —C═C—, and more preferably —CHRCHR—, —OCHR—, —CHRO—, or —C═C—.

In Formula (II), A¹ and A² each independently represent an aromatic hydrocarbon ring group or an aromatic heterocyclic group, which may have a substituent.

A¹ and A² have the same definition as A¹ and A² in Formula (I), and the suitable aspect thereof is also the same.

B¹ and B² each independently represent an aromatic hydrocarbon ring group, an aromatic heterocyclic group, or an aliphatic hydrocarbon ring group, which may have a substituent. In a case where there are a plurality of B¹'s and a plurality of B²'s, the plurality of B¹'s may be the same as or different from each other and the plurality of B²'s may be the same as or different from each other.

The aromatic hydrocarbon ring group may be a monocyclic structure or a polycyclic structure.

The aromatic hydrocarbon ring group is not particularly limited, but is preferably an arylene group, more preferably an arylene group having 6 to 20 carbon atoms, still more preferably an arylene group having 6 to 10 carbon atoms, and particularly preferably a phenylene group or a naphthylene group.

The aromatic heterocyclic group may be a monocyclic structure or a polycyclic structure. Among these, the aromatic heterocyclic group is preferably a 5-membered or 6-membered monocyclic aromatic heterocyclic group. A heteroatom contained in the aromatic heterocyclic group is not particularly limited, and examples thereof include an oxygen atom, a nitrogen atom, and a sulfur atom.

The aromatic heterocyclic group is not particularly limited, but is preferably a heteroarylene group, more preferably a heteroarylene group having 3 to 20 carbon atoms, and still more preferably a heteroarylene group having 3 to 10 carbon atoms. The heteroatom contained in the heteroarylene group is preferably at least one selected from the group consisting of a nitrogen atom, an oxygen atom, and a sulfur atom.

The aliphatic hydrocarbon ring group may have a monocyclic structure or may have a polycyclic structure.

The aliphatic hydrocarbon ring group is not particularly limited, and examples thereof include a cycloalkylene group and the like. Among these, the cycloalkylene group is preferably a cycloalkylene group having 3 to 20 carbon atoms, and more preferably a cycloalkylene group having 3 to 10 carbon atoms.

The substituent which may be contained in the aromatic hydrocarbon ring group, aromatic heterocyclic group, and aliphatic hydrocarbon ring group is not particularly limited, but is preferably a substituent selected from the above-described substituent L.

In Formula (II), n and m each independently represent an integer in a range of 0 to 4.

Among these, n and m each independently preferably represent an integer in a range of 0 to 3, and more preferably represent an integer in a range of 0 to 2.

### (Compound Represented by Formula (III) and Compound Represented by Formula (IV))

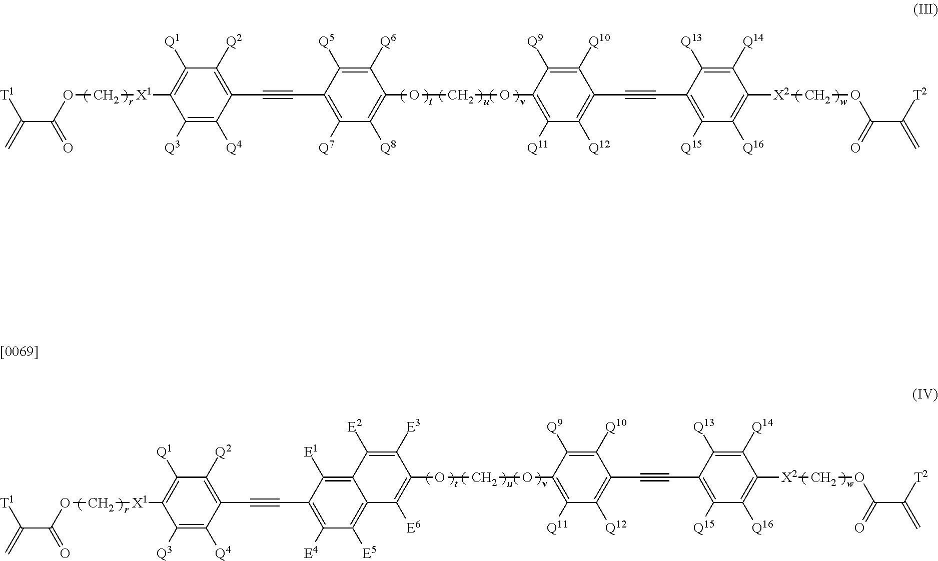

In Formula (III) and Formula (IV), T¹ and T² each independently represent a hydrogen atom or a methyl group.

X¹ and X² each independently represent a methylene group, an oxygen atom, or a sulfur atom.
r represents an integer in a range of 1 to 5.
t and v each independently represent 0 or 1.
u represents 1 or 2.
w represents an integer in a range of 1 to 5.
Q¹ to Q¹⁶ each independently represent a hydrogen atom or a substituent.
E¹ to E⁶ each independently represent a hydrogen atom or a substituent.

The substituent represented by Q¹ to Q¹⁶ is not particularly limited, but is preferably a substituent selected from the above-described substituent L.

The substituent represented by E¹ to E⁶ is not particularly limited, but is preferably a substituent selected from the above-described substituent L.

Specific examples of the specific tolan compound are not particularly limited, and examples thereof include compounds described in JP2009-102245A, JP4655348B, JP4524827B, JP4720200B, JP2004-091380A, JP3972430B, JP4517416B, JP2002-128742A, JP4810750B, JP5888544B, JP2014-019654A, JP6241654B, JP6372060B, JP6323144B, JP2005-015406A, JP2007-230968A, JP6761484B, JP6681992B, WO2019/182129A, CN1134217A, KR101069555B, KR101690767B, CN20120229730A, JP4053782B, JP2009-249406A, JP4121075B, JP2005-528416A, U.S. Pat. No. 6,514,578B, WO2006/006819A, JP2011-184417A, JP2013-095685A, JP2013-103897A, JP2002-088008A, JP2002-226412A, JP2012-167214A, JP2012-167068A, JP2018-084511A, JP2003-055317A, JP2001-329264A, JP2002-030016A, JP2003-055664A, JP2018-070889A, CN102557896B, US 2015369982A, JP2020-105264A, JP2014-224237A, JP2012-051862A, JP2010-106274A, JP2005-179557A, JP2005-035985A, JP2002-012579A, JP2002-003845A, JP2001-233837A, JP2019-532167A, JP2016-509247A, JP2010-503733A, JP2003-533557A, WO2019/098115A, WO2018/034216A, WO2018/221236A, WO2018/123396A, WO2018/003482A, WO2017/086143A, WO2014/192655A, WO2013/161669A, WO2009/104468A.

In addition, examples of the specific tolan compound also include the following compounds.

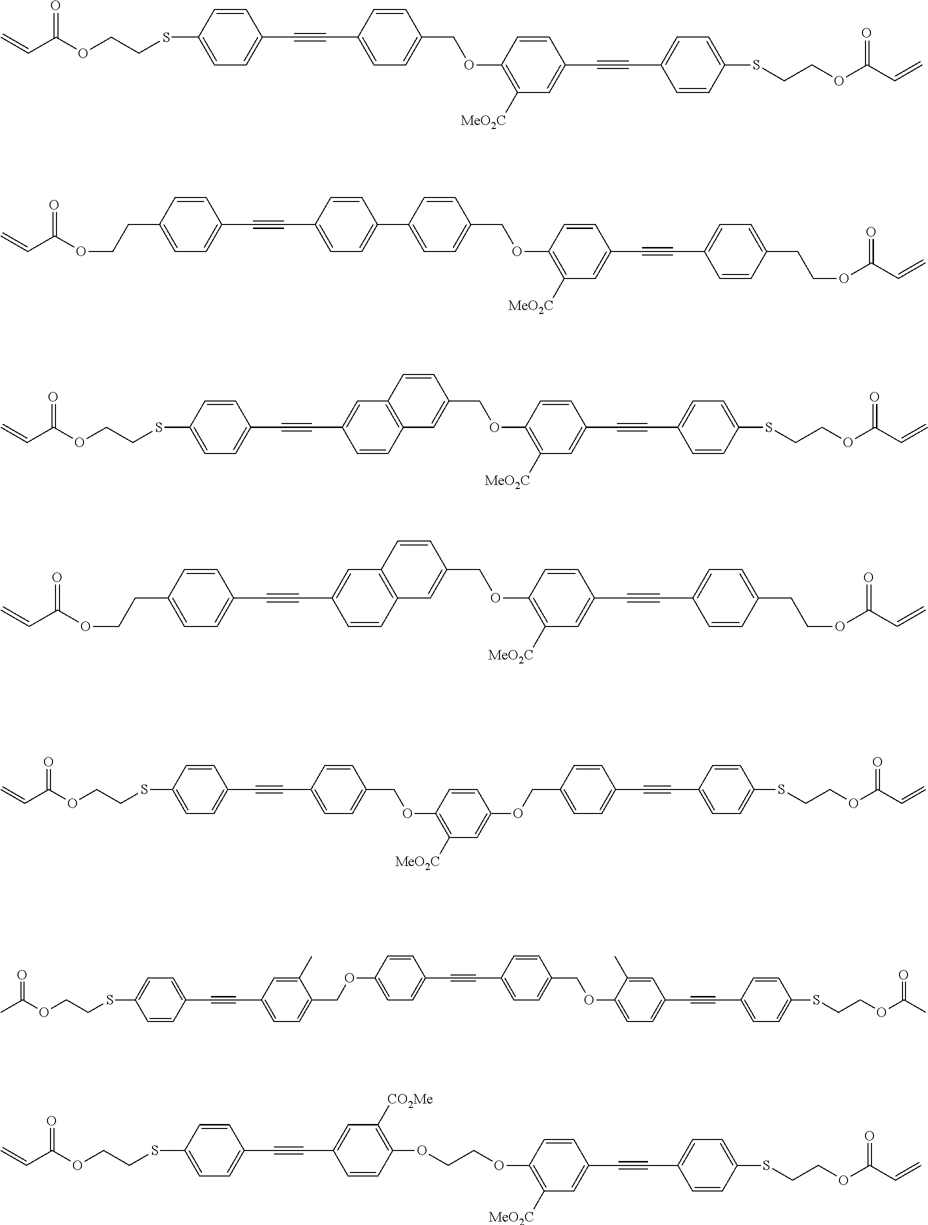

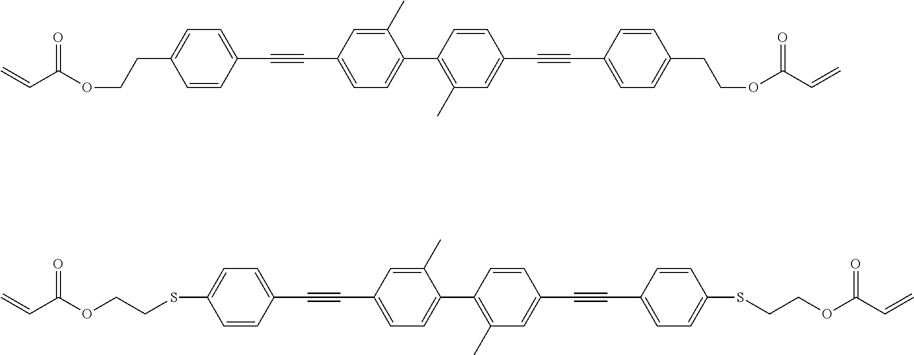

As described above, the specific tolan compound can include a liquid crystalline specific tolan compound (specific tolan compound exhibiting liquid crystallinity) and a non-liquid crystalline specific tolan compound (specific tolan compound not exhibiting liquid crystallinity).

Here, the liquid crystalline specific tolan compound is intended to be a compound having the partial structure represented by Formula (I), in which a transition temperature to a liquid crystal phase in a case of temperature decrease is 1° C. or more. In the refractive index anisotropy Δn of the liquid crystalline specific tolan compound, Δn at a wavelength of 550 nm is preferably 0.20 or more, more preferably 0.24 or more, and still more preferably 0.28 or more.

### (Other Liquid Crystal Compound)

The liquid crystalline composition may contain the other liquid crystal compound (other liquid crystal compounds) having a structure different from that of the specific tolan compound.

In general, the liquid crystal compound can be classified into a rod-like type and a disk-like type according to the shape thereof. Furthermore, the above-described types of compounds respectively include a low-molecular-weight type compound and a polymer type compound. The term, polymer, generally refers to a molecule having a polymerization degree of 100 or more (Masao Doi, Polymer Physics-Phase Transition Dynamics, page 2, Iwanami Shoten, Publishers, 1992).

The other liquid crystal compounds are not particularly limited, and any compound may be used. Among these, from the viewpoint of more excellent effect of the present invention, a rod-like liquid crystal compound or a disk-like liquid crystal compound (discotic liquid crystal compound) is preferable, and a rod-like liquid crystal compound is more preferable.

In addition, the other liquid crystal compounds are also preferably a liquid crystal compound having a polymerizable group in the molecule (a polymerizable liquid crystal compound).

Examples of the polymerizable group include an ethylenically unsaturated group and a ring-polymerizable group, and specific examples thereof include a vinyl group, a styryl group, an allyl group, and a substituent selected from the above-described polymerizable group P.

In a case of containing a polymerizable group in the other liquid crystal compounds, the number of polymerizable groups is not particularly limited, but is, for example, one or more, and from the viewpoint of immobilizing the alignment, the other liquid crystal compounds have more preferably two or more polymerizable groups in one molecule. The upper limit value thereof is, for example, preferably 6 or less and more preferably 3 or less.

The other liquid crystal compounds may be used alone or in combination of two or more types thereof.

In a case where two or more other liquid crystal compounds are used in combination, any form of a mixture of two or more rod-like liquid crystal compounds, a mixture of two or more disk-like liquid crystal compounds, and a mixture of a rod-like liquid crystal compound and a disk-like liquid crystal compound may be adopted.

As the other liquid crystal compounds, known compounds can be used.

As the rod-like liquid crystal compound, for example, compounds described in [claim 1] of JP1999-513019A (JP-H11-513019A) and paragraphs to of JP2005-289980A, and the like can be suitably used.

In addition, as the disk-like liquid crystal compound, for example, compounds described in paragraphs to of JP2007-108732A and paragraphs to of JP2010-244038A, and the like can be suitably used.

From the viewpoint of more excellent effect of the present invention, the other liquid crystal compound is preferably a rod-like liquid crystal compound, and more preferably azomethines, azoxys, cyanobiphenyls, cyanophenyl esters, benzoic acid esters, cyclohexanecarboxylic acid phenyl esters, cyanophenylcyclohexanes, cyano-substituted phenylpyrimidines, alkoxy-substituted phenylpyrimidines, phenyldioxanes, or alkenylcyclohexylbenzonitriles.

The other liquid crystal compounds are more preferably as a refractive index anisotropy Δn is higher, and specifically, Δn at a wavelength of 550 nm is preferably 0.15 or more, more preferably 0.18 or more, and still more preferably 0.22 or more. The upper limit thereof is not particularly limited, but is 0.20 or less in many cases.

### (Content of Specific Tolan Compound and Liquid Crystal Compound)

The content of the liquid crystal compound in the liquid crystalline composition is preferably 50% to 100% by mass, more preferably 65% to 100% by mass, and still more preferably 80% to 100% by mass with respect to the solid content of the liquid crystalline composition.

In addition, the content of the specific tolan compound (the total content of the liquid crystalline specific tolan compound and the non-liquid crystalline specific tolan compound) in the liquid crystalline composition is preferably 20% to 100% by mass, more preferably 50% to 100% by mass, and still more preferably 70% to 100% by mass with respect to the total solid content of the liquid crystalline composition.

### (Preferred Aspects of Liquid Crystalline Composition According to First to Third Aspects)

In a case where the liquid crystalline composition is the liquid crystalline composition according to the first aspect, the liquid crystalline specific tolan compound is preferably a polymerizable liquid crystal compound having two or more polymerizable groups.

In addition, in a case where the liquid crystalline composition is the liquid crystalline composition according to the first aspect, the liquid crystalline specific tolan compound is preferably a rod-like liquid crystal compound.

In a case where the liquid crystalline composition is the liquid crystalline composition according to the second aspect, it is preferable that at least one of the liquid crystalline specific tolan compound or the other liquid crystal compound is a polymerizable liquid crystal compound having two or more polymerizable groups, and it is more preferable that both the liquid crystalline specific tolan compound and the other liquid crystal compound are polymerizable liquid crystal compounds having two or more polymerizable groups.

In a case where the liquid crystalline composition is the liquid crystalline composition according to the second aspect, the content of the liquid crystalline specific tolan compound is preferably 50% by mass or more, more preferably 70% by mass or more, and still more preferably 85% by mass or more with respect to the total content of the liquid crystalline specific tolan compound and the other liquid crystal compound. The upper limit thereof is not particularly limited, but is preferably 95% by mass or less.

In addition, in a case where the liquid crystalline composition is the liquid crystalline composition according to the second aspect, it is preferable that both the liquid crystalline specific tolan compound and the other liquid crystal compound are a rod-like liquid crystal compound.

In a case where the liquid crystalline composition is the liquid crystalline composition according to the third aspect, it is preferable that at least one of the non-liquid crystalline specific tolan compound or the other liquid crystal compound has two or more polymerizable groups, and it is more preferable that both the non-liquid crystalline specific tolan compound and the other liquid crystal compound have two or more polymerizable groups.

In a case where the liquid crystalline composition is the liquid crystalline composition according to the third aspect, the content of the non-liquid crystalline specific tolan compound is preferably 20% by mass or more, more preferably 30% by mass or more, still more preferably 40% by mass or more, and particularly preferably 50% by mass or more with respect to the total content of the non-liquid crystalline specific tolan compound and the other liquid crystal compound. The upper limit is not particularly limited, but is preferably 80% by mass or less and more preferably 60% by mass or less.

In addition, in a case where the liquid crystalline composition is the liquid crystalline composition according to the third aspect, it is preferable that the other liquid crystal compound is a rod-like liquid crystal compound.

### (Polymerization Initiator)

The liquid crystalline composition preferably contains a polymerization initiator.

The polymerization initiator is preferably a photopolymerization initiator capable of initiating a polymerization reaction by ultraviolet irradiation. Examples of the photopolymerization initiator include a-carbonyl compounds (described in each of US2367661A and US2367670A), acyloin ethers (described in US2448828A), a-hydrocarbon substituted aromatic acyloin compounds (described in US2722512A), polynuclear quinone compounds (described in each of US3046127A and US2951758A), combinations of triarylimidazole dimers and p-aminophenyl ketones (described in US3549367A), acridine and phenazine compounds (described in JP1985-105667A (JP-S60-105667A) and US4239850A), oxadiazole compounds (described in US4212970A), and acylphosphine oxide compounds (described in JP1988-040799B (JP-S63-040799B), JP1993-029234B (JP-H5-029234B), JP1998-95788A (JP-H10-95788A), and JP1998-29997A (JP-H10-29997A).

In a case where the liquid crystalline composition contains a polymerization initiator, the content of the polymerization initiator in the liquid crystalline composition is preferably 0.1% to 20% by mass and more preferably 1% to 10% by mass with respect to the content of the liquid crystal compound.

In the liquid crystalline composition, the polymerization initiator may be used alone or in combination of two or more types. In a case where two or more types are used, the total content thereof is preferably within the above-described range.

### (Surfactant)

The liquid crystalline composition may contain a surfactant which contributes to stable or rapid formation of a liquid crystal phase.

Examples of the surfactant include a fluorine-containing (meth)acrylate-based polymer, compounds represented by General Formulae (X1) to (X3) described in WO2011/162291A, compounds represented by General Formula (I) described in paragraphs to of JP2014-119605A, and compounds described in paragraphs to of JP2013-047204A. At an air interface of a layer, these compounds can reduce a tilt angle of molecules of a liquid crystal compound or can cause a liquid crystal compound to be substantially horizontally aligned.

In the present specification, “horizontal alignment” means that the molecular axis of the liquid crystal compound (in a case where the liquid crystal compound is a rod-like liquid crystal compound, corresponding to a long axis of the liquid crystal compound) and the film surface are parallel to each other, but it is not required to be strictly parallel. In the present specification, “horizontal alignment” means an alignment in which the tilt angle formed with the film surface is less than 20 degrees. In a case where the liquid crystal compound is horizontally aligned near the air interface, alignment defects are less likely to occur, so that transparency in a visible light region is increased. On the other hand, in a case where the molecules of the liquid crystal compound are aligned at a large tilt angle, for example, in a case of cholesteric phase, since a spiral axis thereof deviates from a normal line of the film surface, reflectivity may decrease, fingerprint patterns may occur, or haze may increase or diffractivity may be exhibited, which are not preferable.

Examples of the fluorine-containing (meth)acrylate-based polymer that can be used as a surfactant also include polymers disclosed in paragraphs to of JP2007-272185A.

In a case where the liquid crystalline composition contains a surfactant, the content of the surfactant in the liquid crystalline composition is not particularly limited, but is preferably 0.001% to 10% by mass and more preferably 0.05% to 3% by mass with respect to the total mass of the liquid crystal compound.

In the liquid crystal composition, the surfactant may be used alone or in combination of two or more types thereof. In a case where two or more types are used, the total content thereof is preferably within the above-described range.

### (Solvent)

The liquid crystalline composition may contain a solvent.

The solvent is preferably a solvent capable of dissolving each component formulated in the liquid crystalline composition, and examples thereof include ketones (for example, acetone, 2-butanone, methyl ethyl ketone, methyl isobutyl ketone, cyclohexanone, cyclopentanone, and the like), ethers (for example, dioxane, tetrahydrofuran, and the like), aliphatic hydrocarbons (for example, hexane and the like), alicyclic hydrocarbons (for example, cyclohexane and the like), aromatic hydrocarbons (for example, toluene, xylene, trimethylbenzene, and the like), halogenated carbons (dichloromethane, dichloroethane, dichlorobenzene, chlorotoluene, and the like), esters (for example, methyl acetate, ethyl acetate, butyl acetate, and the like), water, alcohols (for example, ethanol, isopropanol, butanol, cyclohexanol, and the like), cellosolves (for example, methyl cellosolve, ethyl cellosolve, and the like), cellosolve acetates, sulfoxides (for example, dimethyl sulfoxide and the like), and amides (for example, dimethylformamide, dimethylacetamide, and the like), and the like.

In a case where the liquid crystalline composition contains a solvent, the content of the solvent in the liquid crystalline composition is preferably 0.5% to 30% by mass and more preferably 1% to 20% by mass, as the concentration of solid contents.

In the liquid crystalline composition, the solvent may be used alone or in combination of two or more types thereof. In a case where two or more types are used, the total content thereof is preferably within the above-described range.

### (Chiral Agent)

The liquid crystalline composition may contain a chiral agent.

The chiral agent (optically active compound) has a function of causing a helical structure of a cholesteric liquid crystalline phase to be formed. The chiral agent may be selected according to the purpose since the induced helical twisted direction or helical pitch varies depending on the compound.

The chiral agent is not particularly limited, and for example, a compound described in “Liquid Crystal Device Handbook, Chapter 3, Article 4-3, chiral agent for twisted nematic (TN) or super twisted nematic (STN), p. 199, edited by No. 142 Committee of Japan Society for the Promotion of Science, 1989”, isosorbide, an isomannide derivative, and the like can be used.

The chiral agent generally contains an asymmetric carbon atom, but an axially chiral compound or a planar chiral compound containing no asymmetric carbon atom can also be used as the chiral agent. Examples of the axially chiral compound or the planar chiral compound include binaphthyl, helicene, paracyclophane, and derivatives thereof.

In addition, the chiral agent may include a polymerizable group. In a case where both the chiral agent and the liquid crystal compound contain polymerizable groups, a polymer that includes a repeating unit derived from a polymerizable liquid crystal compound and a repeating unit derived from the chiral agent can be formed by a polymerization reaction of a polymerizable chiral agent and the polymerizable liquid crystal compound. In this aspect, the polymerizable group contained in the polymerizable chiral agent is preferably the same group as the polymerizable group contained in the polymerizable liquid crystal compound.

Furthermore, the chiral agent itself may be the liquid crystal compound.

In a case where the chiral agent has a photoisomerization group, a pattern having a desired reflection wavelength corresponding to a luminescence wavelength can be formed by irradiation with actinic ray or the like through a photo mask after coating and alignment, which is preferable. As the photoisomerization group, an isomerization site of a compound exhibiting photochromic properties, an azo group, an azoxy group, or a cinnamoyl group is preferable. Specific examples of the compound include compounds described in JP2002-080478A, JP2002-080851A, JP2002-179668A, JP2002-179669A, JP2002-179670A, JP2002-179681A, JP2002-179682A, JP2002-338575A, JP2002-338668A, JP2003-313189A, JP2003-313292A, and the like.

In a case where the liquid crystalline composition contains a chiral agent, the content of the chiral agent in the liquid crystalline composition is not particularly limited, but is preferably 0.01% to 15% by mass and more preferably 1.0% to 10% by mass with respect to the content of the liquid crystal compound.

### (Other Additives)

The liquid crystalline composition may contain other additives in addition to the above-described components.

Examples of the other additives include an antioxidant, an ultraviolet absorber, a sensitizer, a stabilizer, a plasticizer, a chain transfer agent, a polymerization inhibitor, an antifoaming agent, a leveling agent, a thickener, a flame retardant, a surfactant, a dispersant, and a color material such as a dye and a pigment.

### (Δn of Liquid Crystalline Composition)

From the viewpoint that the diffraction efficiency of the laminate is further increased, in the refractive index anisotropy Δn of the liquid crystalline composition, Δn at a wavelength of 550 nm is preferably 0.21 or more, more preferably 0.25 or more, still more preferably 0.28 or more, and particularly preferably 0.30 or more. The upper limit value is not particularly limited, but for example, is preferably 0.80 or less.

In addition, the refractive index anisotropy Δn of the liquid crystalline composition can be measured by the following method. In a case where the liquid crystalline composition contains a solvent as follows, the solvent is removed from the liquid crystalline composition, and Δn is measured.

### (Method for Measuring an)

Δn of each liquid crystalline composition is measured by a method using a wedge-shaped liquid crystal cell, which is described on page 202 of Liquid Crystal Handbook (edited by the Liquid Crystal Handbook Editorial Committee, published by MARUZEN CO., LTD.). In a case where the liquid crystalline composition contains a solvent, the liquid crystalline composition is dried on a hot plate at 120° C. in advance, and the composition obtained by removing the solvent is used to measure Δn.

In addition, it is also preferable that the optically-anisotropic layer can be made to have a substantially wide range for the wavelength of incidence light by imparting a twist component to the liquid crystal composition or by laminating different retardation layers. For example, in the optically anisotropic layer, a method of realizing a λ/2 plate having a wide-range pattern by laminating two liquid crystal layers having different twisted directions is disclosed in, for example, JP2014-089476A and can be suitably used in the laminate according to the embodiment of the present invention.

### <Method for Producing Optically Anisotropic Layer 1>

The optically anisotropic layer 1 is a layer obtained by curing the above-mentioned liquid crystalline composition.

Specific examples of the method for producing the optically anisotropic layer 1 include an aspect in which a step X of bringing a substrate including an alignment film having a predetermined alignment pattern into contact with a liquid crystalline composition to form a composition layer on the alignment film on the substrate, and a step Y of subjecting the composition layer to a heat treatment to align the liquid crystal compound, and then subjecting the same to a curing treatment are included.

After the production of the optically anisotropic layer 1, the above-described substrate may be removed from the optically anisotropic layer, or may not be removed. In addition, in the same manner, the above-described alignment film may be removed from the optically anisotropic layer after the production of the optically anisotropic layer 1, or may not be removed.

In addition, the above-described substrate may be an oxygen barrier layer (for example, a glass substrate and the like), which will be described later.

As described above, in the laminate 10 of FIG. 1, for example, the alignment film may be interposed between the optically anisotropic layer 1 and the oxygen barrier layer 2A or between the optically anisotropic layer 1 and the oxygen barrier layer 2B. In a case of using the laminate 10 of the above-described aspect, for example, the alignment film may be formed on the oxygen barrier layer, and the optically anisotropic layer may be formed on the alignment film.

Hereinafter, specific procedures for the step X and the step Y will be described in detail.

### (Step X)

### Substrate

In the step X, the type of the substrate to be used is not particularly limited, and examples thereof include known substrates (for example, a resin substrate, a glass substrate, a ceramic substrate, a semiconductor substrate, and a metal substrate).

### Alignment Film

An alignment film is disposed on the substrate. In a case where the alignment film is present, the liquid crystal compound 30 is easily aligned in a predetermined liquid crystal alignment pattern in the production of the optically anisotropic layer 1. As described above, the optically anisotropic layer 1 has a liquid crystal alignment pattern in which the orientation of the optical axis 30A (see FIG. 3) derived from the liquid crystal compound 30 is changed while continuously rotating along one in-plane direction (x direction). Therefore, the alignment film is formed such that the optically anisotropic layer can form the liquid crystal alignment pattern.

Various known alignment films can be used. Examples of the alignment film include a rubbed film formed of an organic compound such as a polymer, an obliquely deposited film formed of an inorganic compound, a film having a microgroove, and a film formed by lamination of Langmuir-Blodgett (LB) films formed with a Langmuir-Blodgett's method using an organic compound such as @-tricosanoic acid, dioctadecylmethylammonium chloride, or methyl stearate.

The alignment film by the rubbing treatment can be formed by rubbing the surface of the polymer layer several times in a certain direction with paper or cloth.

As the material used for the alignment film, polyimide, polyvinyl alcohol, a polymer having a polymerizable group described in JP1997-152509A (JP-H9-152509A), and a material used for forming an alignment film described in JP2005-097377A, JP2005-099228A, JP2005-128503A, and the like, can be suitably used.

In addition, as the alignment film, a so-called photo-alignment film obtained by irradiating a photo-alignment material with polarized or non-polarized light to form an alignment film can be suitably used. In a case of being irradiated with polarized light to form the alignment film, the alignment film can be formed by irradiating the photo-alignment material with polarized light from a vertical direction or an oblique direction, and in a case of being irradiated with non-polarized light to obtain the alignment film, the alignment film can be formed by irradiating the photo-alignment material with non-polarized light from an oblique direction.

Examples of the photo-alignment material used in the photo-alignment film include an azo compound described in JP2006-285197A, JP2007-76839A, JP2007-138138A, JP2007-94071A, JP2007-121721A, JP2007-140465A, JP2007-156439A, JP2007-133184A, JP2009-109831A, JP3883848B, and JP4151746B, an aromatic ester compound described in JP2002-229039A, a maleimide- and/or alkenyl-substituted nadiimide compound having a photo-alignable unit described in JP2002-265541A and JP2002-317013A, a photocrosslinking silane derivative described in JP4205195B and JP4205198B, a photocrosslinking polyimide, a photocrosslinking polyamide, and a photocrosslinking ester described in JP2003-520878A, JP2004-529220A, and JP4162850B, and a photodimerizable compound, in particular, a cinnamate compound, a chalcone compound, a coumarin compound, and the like described in JP1997-118717A (JP-H9-118717A), JP1998-506420A (JP-H10-506420A), JP2003-505561A, WO2010/150748A, JP2013-177561A, and JP2014-12823A. Among these, an azo compound, a photocrosslinking polyimide, a photocrosslinking polyamide, a photocrosslinking ester, a cinnamate compound, a chalcone compound, or the like can be suitably used.

The thickness of the alignment film is not particularly limited and may be appropriately set according to the material for forming the alignment film such that a required alignment function can be obtained.

The thickness of the alignment film is preferably 0.01 to 5 μm and more preferably 0.05 to 2 μm.

The method of forming the alignment film is not particularly limited, and various known methods can be used according to the material for forming the alignment film.

From the viewpoint that the alignment pattern of the optically anisotropic layer 1 is more easily formed, a photo-alignment film is preferable, which is obtained by irradiating the photo-alignment material with polarized or non-polarized light to form an alignment film. A method described in [0078] to [0080] and [FIG. 5] of WO2020/022496A can be suitably applied.

### Procedure of Step X

A method of bringing a substrate including an alignment film having a predetermined alignment pattern (hereinafter, also referred to as “substrate with an alignment film”) into contact with the liquid crystalline composition is not particularly limited, and examples thereof include a method of applying the composition onto the alignment film on the substrate and a method of immersing the above-described substrate with the alignment film in the composition.

After the substrate with an alignment film is brought into contact with the composition, a drying treatment may be performed as necessary to remove a solvent from the composition layer disposed on the alignment film on the substrate.

### (Step Y)

The step Y is a step of subjecting the composition layer to a heat treatment to align the liquid crystal compound, and then subjecting the same to a curing treatment. By subjecting the composition layer to a heat treatment, the liquid crystal compound is aligned to form a liquid crystal phase. For example, in a case where the composition layer contains a chiral agent, a cholesteric liquid crystalline phase is formed.

Conditions of the heat treatment are not particularly limited, and optimum conditions are selected depending on the type of the liquid crystal compound.

The method of the curing treatment is not particularly limited, and examples thereof include photo-curing treatment and thermosetting treatment. Above all, a light irradiation treatment is preferable, and an ultraviolet irradiation treatment is more preferable.

A light source such as an ultraviolet lamp is used for ultraviolet irradiation.

The cured product that is obtained by the above treatment corresponds to a layer that is obtained by immobilizing a liquid crystal phase. In particular, in a case where the liquid crystalline composition contains a chiral agent, a layer is formed in which a cholesteric liquid crystalline phase is immobilized.

These layers do not need to exhibit liquid crystallinity anymore. More specifically, for example, as a state in which the cholesteric liquid crystalline phase is “immobilized,” the most typical and preferred aspect is a state in which the alignment of the liquid crystal compound, which is the cholesteric liquid crystalline phase, is retained. More specifically, it is preferably a state in which within a temperature range of usually 0° C. to 50° C., or −30° C. to 70° C. under the more severe conditions, no fluidity is exhibited in the layer, no changes in alignment form occur due to an external field or an external force, and a fixed alignment form can be kept stably and continuously.

In addition, in the step Y, the optically anisotropic layer in a semi-cured state may be formed by a curing treatment, the oxygen barrier layer may be disposed on the optically anisotropic layer, and then the optically anisotropic layer may be additionally cured. In a case where the additionally curing of the optically anisotropic layer is performed after the oxygen barrier layer is disposed, the curing treatment of the optically anisotropic layer proceeds in the absence of singlet oxygen, which is the polymerization inhibitor. Therefore, the light resistance of the formed laminate is more likely to be improved.

As described above, the substrate may be an oxygen barrier layer (an oxygen barrier layer having an oxygen permeability coefficient at 25° C. and 50% RH of 1.0×10⁻¹¹ cm³·cm/(cm²·s·mmHg) or less).

### <<Oxygen Barrier Layer>>

The laminate 10 has a pair of oxygen barrier layers (2A and 2B) disposed on both sides of the optically anisotropic layer 1.

In each oxygen barrier layer of the oxygen barrier layers 2A and 2B, the oxygen permeability coefficient at 25° C. and 50% RH is 1.0×10⁻¹¹ cm³·cm/(cm²·s·mmHg) or less, and from the viewpoint of more excellent effect of the present invention, is preferably 1.0×10⁻¹² cm³·cm/(cm²·s·mmHg) or less and more preferably 1.0×10⁻¹³ cm³·cm/(cm²·s·mmHg) or less. The lower limit value thereof is not particularly limited, but is, for example, preferably 1.0×10⁻²⁰ cm³·cm/(cm²·s·mmHg) or more.

The oxygen permeability coefficient of each oxygen barrier layer of the oxygen barrier layers 2A and 2B at 25° C. and 50% RH can be measured by an equal pressure method according to ISO 15105-2.

In addition, in each oxygen barrier layer of the oxygen barrier layers 2A and 2B, the value obtained by dividing the oxygen permeability coefficient [cm³·cm/(cm²·s·mmHg)] at 25° C. and 50% RH by the film thickness [μm] is preferably 1.0×10⁻¹¹ or less, more preferably 1.0×10⁻¹² or less, and still more preferably 1.0×10⁻¹³ or less. The lower limit value thereof is not particularly limited, but is preferably 1.0×10⁻²⁰ or more.

In addition, in each oxygen barrier layer of the oxygen barrier layers 2A and 2B, the transmittance is preferably 70% or more, more preferably 75% or more, and still more preferably 80% or more. The transmittance is intended to be an average transmittance of visible light having a wavelength of 400 to 700 nm.

The transmittance is a value measured at 25° C. using a spectrophotometer (for example, spectrophotometer UV-3100PC manufactured by Shimadzu Corporation).

Examples of a material constituting the oxygen barrier layers 2A and 2B include glass and a resin.

The resin constituting the oxygen barrier layers 2A and 2B is not particularly limited, and examples thereof include an ethylene-vinyl alcohol copolymer, polyamide, polyvinyl alcohol, polyacrylonitrile, polyvinylidene chloride, and the like.

In addition, the organic molecular films described in JP2014-218444A and JP2014-218548A, the barrier films described in JP2020-188047A, the coating films described in JP2020-186281A, and the like can also be applied as the oxygen barrier layers 2A and 2B.

In addition, the oxygen barrier layers 2A and 2B may be a polarizing plate.

In addition, the oxygen barrier layers 2A and 2B may contain an inorganic filler. The inorganic filler is the same as the inorganic filler contained in the water vapor barrier layer, which will be described later.

In the laminate 10, an aspect in which one of the oxygen barrier films 2A and 2B is glass and the other is non-glass (for example, a resin or the like) is also preferable.

A lower limit of the thickness of the oxygen barrier layer is not particularly limited, but from the viewpoint of more excellent oxygen barrier properties, is preferably 0.01 μm or more, more preferably 0.1 μm or more, and still more preferably 1 μm or more. As the thickness of the oxygen barrier layer is increased, the oxygen barrier properties are enhanced. Therefore, the upper limit value of the thickness of the oxygen barrier layer is not particularly limited, but for example, in a case where the oxygen barrier layer is made of glass, from the viewpoint of making the thickness of the entire laminate thin and suppressing the weight, the upper limit value thereof is preferably 2 cm or less, more preferably 1 cm or less, and still more preferably 5 mm or less. In addition, for example, in a case where the oxygen barrier layer is a resin, from the viewpoint of making the thickness of the entire laminate thin and excellent productivity, the upper limit value thereof is preferably 2 cm or less, more preferably 1 cm or less, still more preferably 5 mm or less, even still more preferably 100 μm or less, particularly preferably 50 μm or less, particularly more preferably 30 μm or less, and most preferably 10 μm or less.

### (Relationship Between Oxygen Barrier Layer and Optically Anisotropic Layer)

In a case where the liquid crystalline composition for forming the optically anisotropic layer 1 is the above-described liquid crystalline composition of the aspect 1, the distance ΔHSP between the HSP value of the main component contained in the oxygen barrier layer 2A (and/or the oxygen barrier layer 2B) and the HSP value of the specific tolan compound is preferably larger than 3.5 MPa^{0.5}, more preferably 4.0 MPa^{0.5} or more, still more preferably 5.0 MPa^{0.5} or more, and particularly preferably 7.0 MPa^{0.5} or more. The upper limit value thereof is not particularly limited, but is preferably 13.0 MPa^{0.5} or less.

In a case where the liquid crystalline composition for forming the optically anisotropic layer 1 is the above-described liquid crystalline composition of the aspect 2 or the aspect 3, the distance ΔHSP between the HSP value of the main component contained in the oxygen barrier layer 2A (and/or the oxygen barrier layer 2B) and the average HSP value of the specific tolan compound and the other liquid crystal compound is preferably larger than 3.5 MPa^{0.5}, more preferably 4.0 MPa^{0.5} or more, still more preferably 5.0 MPa^{0.5} or more, and particularly preferably 7.0 MPa^{0.5} or more. The upper limit value thereof is not particularly limited, but is preferably 13.0 MPa^{0.5} or less.

With the above-described configuration, the movement of the molecules of the specific tolan compound and the other liquid crystal compound (particularly, the specific tolan compound and the other liquid crystal compound, which are not immobilized by polymerization) to the oxygen barrier layer can be suppressed, and as a result, the light resistance of the laminate can be further improved.

The distance ΔHSP value is obtained by the following procedure.

(1) First, using the commercially available software “HSPiP”, three vectors of Hansen solubility parameter (dispersion element component of Hansen solubility parameter vector: δD, polar element component of Hansen solubility parameter vector: δP, and hydrogen bonding element component of Hansen solubility parameter vector: δH) are obtained for each of the main component constituting the oxygen barrier layer, the specific tolan compound, and the other liquid crystal compound.

Here, the main component constituting the oxygen barrier layer is, for example, SiO₂ in a case where the oxygen barrier layer is made of glass.

In addition, for example, in a case where the main component constituting the oxygen barrier layer is a resin, an average δD, an average δP, and an average δH obtained from δD, δP, and SH of each raw material monomer constituting the resin and a content of each raw material monomer (mass fraction: content ratio of each raw material monomer with respect to the total content of the each raw material monomer) are regarded as δD, δP, and δH of the main component constituting the oxygen barrier layer by the same method as the method in the procedure (2) which will be described.

(2) In a case where the liquid crystalline composition contains both the specific tolan compound and the other liquid crystal compound, the average δDₓ of the specific tolan compound and the other liquid crystal compound is calculated according to the following expression.

$$Average δ {D}_{x} = δ {D}_{1} \times {W}_{1} + δ {D}_{2} \times {W}_{2} + … δ {D}_{n} \times {W}_{n}$$

Here, δDₙ represents δD of each compound corresponding to the specific tolan compound and the other liquid crystal compound, and Wₙ represents a content of each compound (mass fraction: content ratio of each compound with respect to the total content of each compound) described above.

For example, in a case where the optically anisotropic layer contains the specific tolan compound and the other liquid crystal compound in equal amount to each, the average δDₓ=δD₁×W₁+δD₂×W₂ (δD₁ and δD₂ each represent δD of the specific tolan compound and the other liquid crystal compound, and W₁ and W₂ represent 0.5).

(3) According to the same procedure as in (2), the average δPₓ and the average δHₓ of the specific tolan compound and the other liquid crystal compound are each calculated.

(4) The distance ΔHSP is derived according to the following expression.

$$ΔHSP value = {\{ 4 \times {( δ {D}_{A} - δ {D}_{B} )}^{2} + {( δ {P}_{A} - δ {P}_{B} )}^{2} + {( δ {H}_{A} - δ {H}_{B} )}^{2} \}}^{0.5}$$

Here, in a case where the liquid crystalline composition contains both the specific tolan compound and the other liquid crystal compound, δD_{A}, δP_{A}, and δH_{A} each represent an average δDₓ, an average δPₓ, and an average δHₓ of the specific tolan compound and the other liquid crystal compound. In a case where the liquid crystalline composition contains only the specific tolan compound and does not contain other liquid crystal compounds, δD_{A}, δP_{A}, and δH_{A} each represent δD, δP, and δH of the specific tolan compound. In addition, δD_{B}, δP_{B}, and δH_{B} represent δD, δP, and δH of the main component constituting the oxygen barrier layer.

### <<Water Vapor Barrier Layer>>

The laminate 10 includes the water vapor barrier layers 4A and 4B, and thus the light resistance is more excellent.

The resins constituting the water vapor barrier layers 4A and 4B are not particularly limited, and examples thereof include polyolefin-based resins such as polypropylene, polyethylene, high-density polyethylene, cyclic olefin polymer, and cyclic olefin copolymer, resins containing a halogen atom, such as polyvinyl chloride and polychlorotrifluoroethylene, and the like.

In addition, the water vapor barrier layers 4A and 4B may contain an inorganic filler. In a case where the water vapor barrier layers 4A and 4B contain an inorganic filler, the water vapor barrier properties are further improved.

Examples of the inorganic filler contained in the water vapor barrier layers 4A and 4B include layered silicates such as talc, mica, kaolin, clay, and bentonite, silica, calcium carbonate, magnesium carbonate, calcium sulfate, magnesium sulfate, barium sulfate, glass filler, glass fiber, glass beads, titanium oxide, aluminum oxide, iron, zinc, aluminum, and the like.

In each water vapor barrier layer of the water vapor barrier layers 4A and 4B, the water vapor permeability at 40° C. and 90% RH is preferably 100 g/(m²·day) or less, more preferably 40 g/(m²·day) or less, and still more preferably 20 g/(m²·day) or less. The lower limit value thereof is not particularly limited, but is, for example, preferably 0.01 g/(m²·day) or more.

The water vapor barrier properties of the water vapor barrier layers 4A and 4B at 40° C. and 90% RH can be measured by a cup method with reference to JIS-Z-0208 (1976).

Thicknesses of the water vapor barrier layers 4A and 4B are not particularly limited, but from the viewpoint that the water vapor barrier properties are more excellent, the thickness thereof is preferably 0.01 μm or more, more preferably 0.1 μm or more, and still more preferably 1 μm or more. As the thickness of the water vapor barrier layers 4A and 4B is increased, the water vapor barrier properties are enhanced. Therefore, an upper limit value of the thickness of the water vapor barrier layers 4A and 4B is not particularly limited, but from the viewpoint of making the thickness of the entire laminate thin, the upper limit value thereof is, for example, preferably 1,000 μm or less, more preferably 500 μm or less, and still more preferably 200 μm or less.

### <<Modification Example of Optically Anisotropic Layer>>

Hereinafter, a modification example of the optically anisotropic layer 1 included in the laminate 10 shown in FIG. 1 will be described.

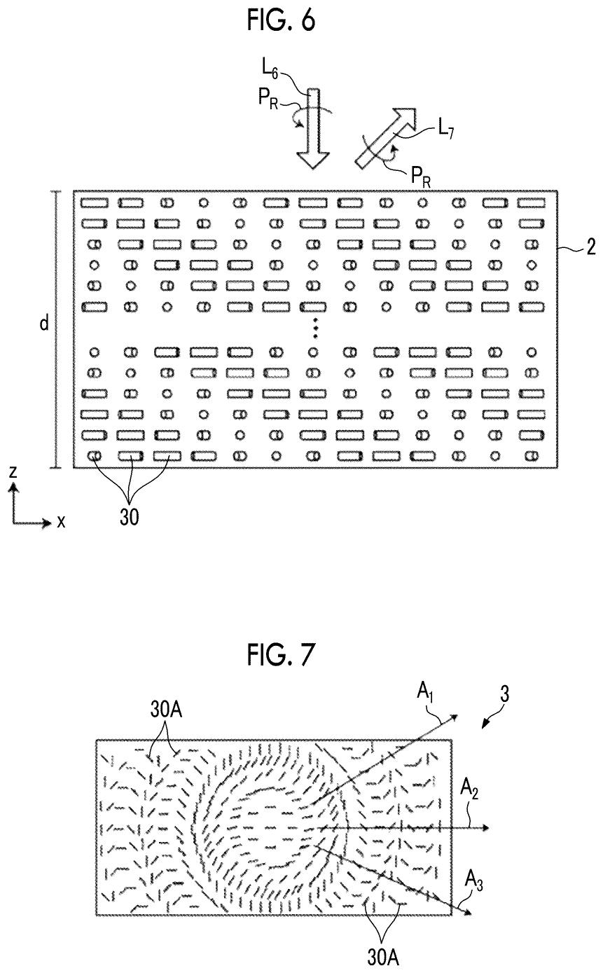

The optically anisotropic layer 2 shown in FIG. 6 is an optically anisotropic layer in which the liquid crystal compound 30 is cholesterically aligned in a thickness direction. It is known that a cholesteric liquid crystalline phase exhibits selective reflectivity at a specific wavelength. The center wavelength λ of selective reflection (selective reflection center wavelength 2) depends on a pitch P (=helical period) of a helical structure in the cholesteric liquid crystalline phase and satisfies a relationship of λ=n×P with an average refractive index n of the cholesteric liquid crystalline phase. Therefore, the selective reflection center wavelength can be adjusted by adjusting the pitch of the helical structure.

The cholesteric liquid crystalline phase exhibits selective reflectivity with respect to either levorotatory or dextrorotatory circularly polarized light at a specific wavelength. Whether the reflected light is dextrorotatory circularly polarized light or levorotatory circularly polarized light depends on the twisted direction (sense) of the helix of the cholesteric liquid crystalline phase. Regarding the selective reflection of circularly polarized light by the cholesteric liquid crystalline phase, dextrorotatory circularly polarized light is reflected in a case where the helical twisted direction of the cholesteric liquid crystalline phase is right, and levorotatory circularly polarized light is reflected in a case where the helical twisted direction is left.

In addition, a half-width Δλ² (nm) of a selective reflection range (circularly polarized light reflection range) where selective reflection is exhibited depends on Δn of the cholesteric liquid crystalline phase and the helical pitch P and complies with a relationship of Δλ²=Δn×P. Therefore, the width of the selective reflection range can be controlled by adjusting Δn.

That is, the optically anisotropic layer 2 exhibits a function of selectively reflecting light in a predetermined wavelength range in specific circularly polarized light (dextrorotatory circularly polarized light or levorotatory circularly polarized light).

On the other hand, since the alignment pattern of the optical axis 30A in the in-plane direction of the optically anisotropic layer 2 is the same as the alignment pattern in the optically anisotropic layer 1 shown in FIG. 2, the same effect as the optically anisotropic layer 1 is exhibited. That is, the optically anisotropic layer 2 has the same action as the optically anisotropic layer 1 described above, of changing the absolute phase of the incident light and bending the light in a predetermined direction. Therefore, the optically anisotropic layer 2 has both the action of bending the incidence light to a direction different from the incidence direction and the action of the above-described cholesteric alignment, and reflects light at an angle in a predetermined direction with respect to the reflection direction of specular reflection.

For example, the optically anisotropic layer 2 is designed such that the cholesteric liquid crystalline phase of the optically anisotropic layer 2 reflects dextrorotatory circularly polarized light. In this case, as shown in FIG. 6, in a case where light L₆ which is dextrorotatory circularly polarized light P_{R} is vertically incident into the main surface of the optically anisotropic layer 2, that is, along the normal line, reflected light L₇ which travels in a direction having a tilt with respect to the normal direction is generated. That is, the optically anisotropic layer 2 functions as a reflective type diffraction grating.

In the liquid crystal alignment pattern of the optically anisotropic layer shown in FIGS. 2 to 6, the optical axes 30A of the liquid crystal compound 30 continuously rotate only along the x direction in the plane.

However, in the optically anisotropic layer of the laminate according to the embodiment of the present invention, various configurations can be used as long as the optical axis 30A of the liquid crystal compound 30 continuously rotates along one direction.

FIG. 7 is a schematic plan view of the optically anisotropic layer 3 of the design change example. In FIG. 7, the liquid crystal alignment pattern is shown by the optical axis 30A of the liquid crystal compound. The optically anisotropic layer 3 has a liquid crystal alignment pattern that regions in which the optical axes 30A have the same orientation are provided concentrically, and that the one direction in which the orientation of optical axis 30A is changed while continuously rotating is provided radially from the center of the optically anisotropic layer 3.

In the optically anisotropic layer 3, the orientations of the optical axes 30A are changed while continuously rotating along a large number of directions from the center of the optically anisotropic layer 3 toward the outside, for example, a direction indicated by an arrow A₁, a direction indicated by an arrow A₂, a direction indicated by an arrow A₃, and the like.

In circularly polarized light incident into the optically anisotropic layer 3 having the above-described liquid crystal alignment pattern, an absolute phase changes depending on individual local regions having different orientation of optical axis of the liquid crystal compound 30. In this case, the amount of change in absolute phase in each of the local regions varies depending on the orientation of the optical axis of the liquid crystal compound 30 into which circularly polarized light is incident.

This way, in the optically anisotropic layer 3 having the concentric circular liquid crystal alignment pattern, that is, the liquid crystal alignment pattern in which the optical axis changes while continuously rotating in a radial shape, transmission of incidence light can be allowed as diverging light or converging light depending on the rotation direction of the optical axis of the liquid crystal compound 30 and the direction of circularly polarized light to be incident.

That is, by setting the liquid crystal alignment pattern of the optically anisotropic layer in a concentric circular shape, the optically anisotropic layer exhibits, for example, a function as a convex lens or a concave lens.

Here, in a case where the liquid crystal alignment pattern of the optically anisotropic layer is concentric circular such that the optically anisotropic layer functions as a convex lens, it is preferable that the length of the single period Λ over which the optical axis rotates 180° in the liquid crystal alignment pattern gradually decreases from the center of the optically anisotropic layer 3 toward the outer direction of the one direction in which the optical axis continuously rotates. The refraction angle of light with respect to an incidence direction increases as the length of the single period Λ in the liquid crystal alignment pattern decreases. Therefore, the light focusing power of the optically anisotropic layer 3 can be further improved and the performance as a convex lens can be improved by gradually shortening the single period Λ in the liquid crystal alignment pattern from the center of the optically anisotropic layer 3 toward the outer direction of the one direction in which the optical axis continuously rotates.

In addition, depending on the uses of the laminate such as a concave lens, it is preferable that the length of the single period Λ over which the optical axis rotates 180° in the liquid crystal alignment pattern gradually decreases from the center of the optically anisotropic layer 3 toward the outer direction of the one direction by reversing the direction in which the optical axis continuously rotates. The refraction angle of light with respect to an incidence direction increases as the length of the single period Λ in the liquid crystal alignment pattern decreases. Accordingly, the length of the single period Λ in the liquid crystal alignment pattern gradually decreases from the center of the optically anisotropic layer 3 toward the outer direction in the in-plane direction in which the optical axis continuously rotates. As a result, the light diverging power of the optically anisotropic layer 3 can be improved, and the performance as a concave lens can be improved.

For example, in a case where the laminate is used as a concave lens, it is also preferable that the turning direction of incident circularly polarized light is reversed.

Conversely, the length of the single period Λ in the concentric circular liquid crystal alignment pattern may gradually increase from the center of the optically anisotropic layer 3 toward the outer direction of the one direction in which the optical axis continuously rotates.

Furthermore, depending on the uses of the laminate such as a case where it is desired to provide a light amount distribution in the transmitted light, a configuration in which regions having partially different lengths of the single periods A in the one direction in which the optical axis continuously rotates are provided can also be used instead of the configuration in which the length of the single period Λ gradually changes in the one direction in which the optical axis continuously rotates.

Further, the laminate may include: an optically-anisotropic layer in which the single period Λ is homogeneous over the entire surface; and an optically-anisotropic layer in which regions having different lengths of the single periods A are provided.

In this way, the configuration of changing the length of the single period Λ over which the optical axis rotates 180° in the one direction in which the optical axis continuously rotates can also be used in the configuration shown in FIGS. 2 to 5 in which the optical axis 30A of the liquid crystal compound 30 changes while continuously rotating only in the one direction of the x direction.

For example, by gradually decreasing the single period Λ of the liquid crystal alignment pattern in the x direction, a laminate which transmits light so as to be gathered can be obtained. In addition, by reversing the direction over which the optical axis in the liquid crystal alignment pattern rotates 180°, a laminate which transmits light so as to be diffused only in the x direction can be obtained. By reversing the turning direction of incident circularly polarized light, a laminate that allows transmission of light to be diffused only in the arrow X direction can be obtained.

Furthermore, depending on the uses of the laminate such as a case where it is desired to provide a light amount distribution in the transmitted light, a configuration in which regions having partially different lengths of the single periods A in the x direction are provided can also be used instead of the configuration in which the length of the single period Λ gradually changes in the x direction.

### [Optical Element]

An optical element according to an embodiment of the present invention includes the above-described laminate.

The application of the optical element is not particularly limited, but the optical element can be used for various uses where transmission of light in a direction different from an incidence direction is allowed, for example, an optical path changing member, a light collecting element, a light diffusing element to a predetermined direction, a diffraction element, or the like in an optical apparatus.

Among these, preferred examples of the application include a light guide element. The light guide element typically includes a light guide plate and a diffraction element that is disposed on the light guide plate (preferably, is disposed to be spaced from the light guide plate).

The optical element according to the embodiment of the present invention is suitably used as a diffraction element.

### EXAMPLES

Hereinafter, the present invention will be described in more detail based on Examples. The materials, the amount and ratio of the materials used, how to treat the materials, the treatment procedure, and the like shown in the following examples can be appropriately changed as long as the gist of the present invention is maintained. Accordingly, the scope of the present invention should not be construed as being limited to Examples shown below.

### [Production of Laminate]

Hereinafter, each procedure for the laminate will be described.

### [Formation of Alignment Film]

The following coating liquid for forming an alignment film was continuously applied onto a glass having a thickness of 1.1 mm (corresponding to the oxygen barrier layer B-1) with a #2 wire bar. The support on which the coating film of the coating liquid for forming an alignment film had been formed was dried using a hot plate at 60° C. for 60 seconds to form an alignment film.

Coating liquid for forming alignment film

| | | |
|---|---|---|
| Material for photo-alignment D | 1.00 | part by mass |
| Water | 16.00 | parts by mass |
| Butoxyethanol | 42.00 | parts by mass |
| Propylene glycol monomethyl ether | 42.00 | parts by mass |

Material D for photo alignment

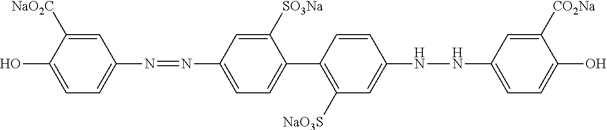

### [Exposure of Alignment Film]

An exposure film was exposed using the exposure device of FIG. 5 of WO2020/022496A to form an alignment film P-1 having an alignment pattern.

In the exposure device, a laser that emits a laser beam having a wavelength of 325 nm was used as the laser. The exposure amount of the interference light was 2,000 mJ/cm². It is noted that one period (the length over which the optical axis derived from the liquid crystal compound rotates) 180° of an alignment pattern formed by interference of two laser beams was controlled by changing the intersecting angle (the intersecting angle β) between the two beams.

### [Formation of Optically Anisotropic Layer]

### (1) Formation of Optically Anisotropic Layer H-1

As a composition forming the optically anisotropic layer, the following composition E-1 was prepared.

Composition E-1

| | | |
|---|---|---|
| The following polymerizable liquid | 90 | parts by mass |
| crystal compound L-1 | | |
| The following polymerizable liquid | 10 | parts by mass |
| crystal compound L-2 | | |
| Polymerization initiator (manufactured by | 3.00 | parts by mass |
| BASF SE, IRGACURE (registered trademark) | | |
| 819) | | |
| The following leveling agent T-1 | 0.08 | parts by mass |
| Methyl ethyl ketone | 927.7 | parts by mass |

Polymerizable liquid crystal compound L-1 (corresponding to liquid crystalline specific tolan compound)

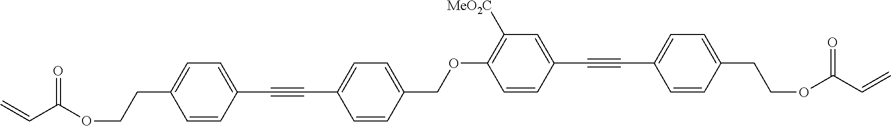 [SMILES: C=CC(=O)OCCc1ccc(C#Cc2ccc(COc3ccc(C#Cc4ccc(CCOC(=O)C=C)cc4)cc3C(=O)OC)cc2)cc1]

Polymerizable liquid crystal compound L-2

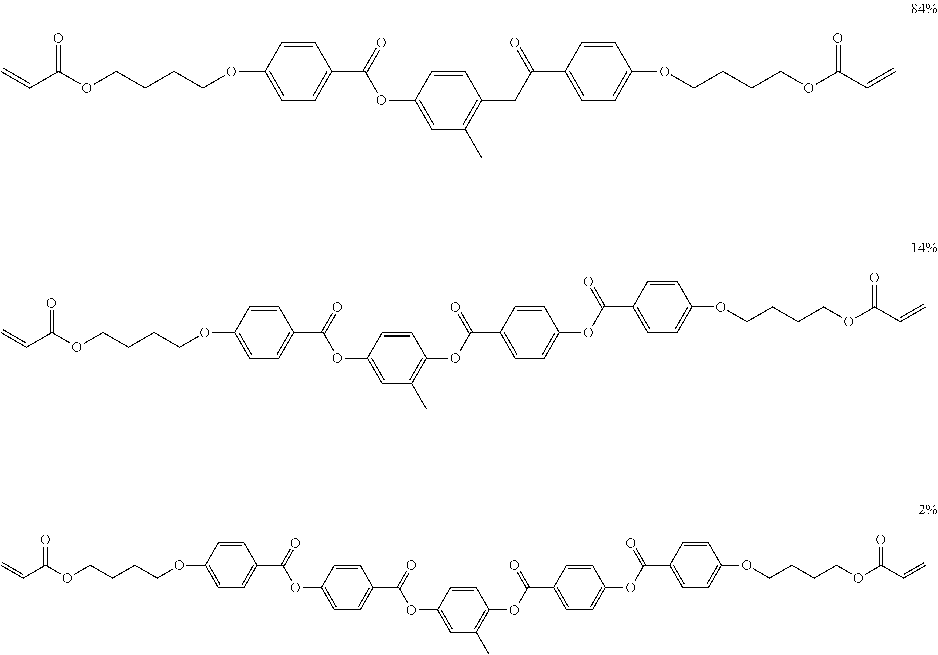

Leveling agent T-1

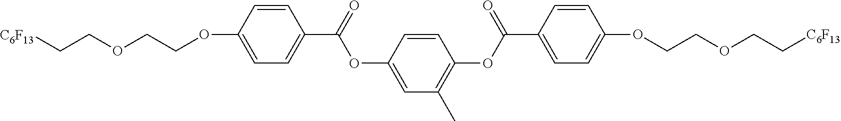

The optically anisotropic layer was formed by applying multiple layers of the composition E-1 to the alignment film P-1. The multilayer coating refers to repeating a procedure in which, first, the composition E-1 is applied for a first layer on an alignment film, heated, and cooled, followed by being cured with ultraviolet rays to produce a liquid crystal immobilized layer, and then, for a second layer and subsequent layers, this liquid crystal immobilized layer is subjected to multiple coating by the application of the composition E-1, heating, and cooling, followed by curing with ultraviolet rays in the same manner. Due to the formation by the multilayer coating, the alignment direction of the alignment film is reflected over the upper surface of the liquid crystal layer from the lower surface (the surface on the alignment film P-1 side) even in a case where the film thickness of the liquid crystal layer is increased.

First, the following composition E-1 was applied for the first liquid crystal layer onto the alignment film P-1 to form a coating film, the coating film was heated to 80° C. using a hot plate and then cooled to 80° C., followed by being irradiated with ultraviolet rays having a wavelength of 365 nm at an irradiation dose of 300 mJ/cm² using a high-pressure mercury lamp in a nitrogen atmosphere, whereby the alignment of the liquid crystal compound was fixed. At this time, the film thickness of the first liquid crystal layer was 0.3 μm.

For the second and subsequent liquid crystal layers, this liquid crystal layer was subjected to multiple coating, heating, and cooling under the same conditions as the first liquid crystal layer, followed by curing with ultraviolet rays to produce a liquid crystal immobilized layer (a cured layer). In this way, multiple coating was repeated until the in-plane retardation (Re) reached 325 nm, and an optically anisotropic layer H-1 was formed.

It was verified using a polarization microscope that the optically anisotropic layer according to the example had a periodically aligned surface as shown in FIG. 2 and FIG. 3, which is described above. In the liquid crystal alignment pattern of the optically anisotropic layer, the single period Λ over which the optical axis derived from the liquid crystal compound rotated by 180° was 1.0 μm. The period Λ was determined by measuring the period of the bright and dark pattern observed under the crossed nicol condition using a polarization microscope.

### (2) Formation of Optically Anisotropic Layer H-2

An optically anisotropic layer H-2 was formed in the same procedure as the procedure for forming the optically anisotropic layer H-1, except that the following composition E-2 was used instead of the composition E-1 used in a case of forming the optically anisotropic layer H-1.

The optically anisotropic layer H-2 was observed with a polarizing microscope in the same manner as in the optically anisotropic layer H-1, and it was confirmed that the optically anisotropic layer H-2 had a periodic alignment surface as shown in FIG. 2 and FIG. 3, which is described above. In addition, in the liquid crystal alignment pattern of the optically anisotropic layer, the single period Λ over which the optical axis derived from the liquid crystal compound rotated by 180° was 1.0 μm.

Composition E-2

| | | |
|---|---|---|
| The following polymerizable liquid | 100 | parts by mass |
| crystal compound L-3 | | |
| Polymerization initiator (manufactured by | 3.00 | parts by mass |
| BASF SE, IRGACURE (registered trademark) | | |
| 819) | | |
| The leveling agent T-1 described above | 0.08 | parts by mass |
| Methyl ethyl ketone | 927.7 | parts by mass |

Polymerizable liquid crystal compound L-3 (corresponding to liquid crystalline specific tolan compound)

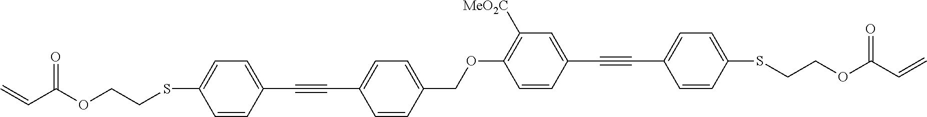 [SMILES: C=CC(=O)OCCSc1ccc(C#Cc2ccc(COc3ccc(C#Cc4ccc(SCCOC(=O)C=C)cc4)cc3C(=O)OC)cc2)cc1]

(3) Formation of optically anisotropic layer H-3

An optically anisotropic layer H-3 was formed in the same procedure as the procedure for forming the optically anisotropic layer H-1, except that the following composition E-3 was used instead of the composition E-1 used in a case of forming the optically anisotropic layer H-1.

The optically anisotropic layer H-3 was observed with a polarizing microscope in the same manner as in the optically anisotropic layer H-1, and it was confirmed that the optically anisotropic layer H-3 had a periodic alignment surface as shown in FIG. 2 and FIG. 3, which is described above. In addition, in the liquid crystal alignment pattern of the optically anisotropic layer, the single period Λ over which the optical axis derived from the liquid crystal compound rotated by 180° was 1.0 μm.

Composition E-3

| | | |
|---|---|---|
| The following polymerizable liquid | 100 | parts by mass |
| crystal compound L-4 | | |
| Polymerization initiator (manufactured by | 3.00 | parts by mass |
| BASF SE, IRGACURE (registered trademark) | | |
| 819) | | |
| The leveling agent T-1 described above | 0.08 | parts by mass |
| Methyl ethyl ketone | 927.7 | parts by mass |

Polymerizable liquid crystal compound L-4 (corresponding to liquid crystalline specific tolan compound)

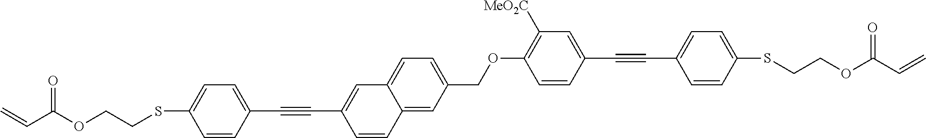 [SMILES: C=CC(=O)OCCSc1ccc(C#Cc2ccc(OCc3ccc4cc(C#Cc5ccc(SCCOC(=O)C=C)cc5)ccc4c3)c(C(=O)OC)c2)cc1]

### (4) Refractive Index Anisotropy Δn of Compositions E-1 to E-3

The refractive index anisotropy Δn of the compositions E-1 to E-3 was measured by the following procedure, and all of the compositions had Δn of 0.21 or more at a wavelength of 550 nm.

### <<Measuring Method>>

The liquid crystalline composition was heated on a hot plate at 120° C. to remove the solvent, thereby producing a measurement sample. Next, the refractive index anisotropy Δn of each measurement sample was measured by a method using a wedge-shaped liquid crystal cell described on page 202 of “Liquid Crystal Handbook” (edited by Liquid Crystal Handbook Editing Committee, published by Maruzen Co., Ltd.).

### [Formation of Oxygen Barrier Layer]

### (1) Formation of Oxygen Barrier Layer B-2

A coating liquid O-2 for an oxygen barrier layer having the following composition was prepared, and the coating liquid was spin-coated on the optically anisotropic layer which had been subjected to a plasma treatment with a plasma cleaner PDC-32G manufactured by Harrick Plasma Co., Ltd., and dried on a hot plate at 100° C. for 60 seconds to form an oxygen barrier layer B-2. A thickness of the formed oxygen barrier layer B-2 was 0.97 μm.

Coating liquid O-2 for oxygen barrier layer

| | | |
|---|---|---|
| The following modified polyvinyl alcohol V-1 | 7.00 | parts by mass |
| Isopropyl alcohol | 21.00 | parts by mass |
| Water | 70.00 | parts by mass |
| Propylene glycol monomethyl ether acetate | 2.00 | parts by mass |

Modified polyvinyl alcohol V-1 (the ratios of repeating units in the following structural formula are in terms of mass ratio)

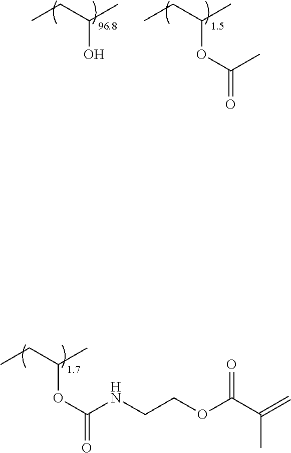

### (2) Formation of Oxygen Barrier Layer B-3

A coating liquid O-3 for an oxygen barrier layer having the following composition was prepared, and the coating liquid was spin-coated on the optically anisotropic layer which had been subjected to a plasma treatment with a plasma cleaner PDC-32G manufactured by Harrick Plasma Co., Ltd., and irradiating the coating film with ultraviolet rays having a wavelength of 365 nm in a nitrogen atmosphere using a high-pressure mercury lamp at an irradiation amount of 300 mJ/cm² to form an oxygen barrier layer B-3. A thickness of the formed oxygen barrier layer B-3 was 0.95 μm.

Coating liquid O-3 for oxygen barrier layer

| | | |
|---|---|---|
| BPE-500 manufactured by Shin-Nakamura | 979.8 | parts by mass |
| Chemical Co., Ltd. | | |
| IRGACURE 127 manufactured by BASF SE | 20.0 | parts by mass |
| The following surfactant F-1 | 0.2 | parts by mass |

Surfactant F-1 (the ratios of repeating units in the following structural formula is in terms of mass ratio)

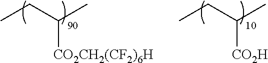

### (3) Formation of Oxygen Barrier Layer B-4

An oxygen barrier layer B-4 was formed by the same procedure as in the case of forming the oxygen barrier layer B-3, except that a coating liquid O-4 for an oxygen barrier layer having the following composition was used instead of the coating liquid O-3 for an oxygen barrier layer used in a case of forming the oxygen barrier layer B-3. A thickness of the formed oxygen barrier layer B-4 was 1.01 μm.

Coating liquid O-4 for oxygen barrier layer

| | | |
|---|---|---|
| A-DCP manufactured by Shin-Nakamura | 979.8 | parts by mass |
| Chemical Co., Ltd. | | |
| IRGACURE 127 manufactured by BASF SE | 20.0 | parts by mass |
| Surfactant F-1 described above | 0.2 | parts by mass |

### (4) Formation of Oxygen Barrier Layer B-5

A coating liquid O-5 for an oxygen barrier layer having the following composition was prepared, and an oxygen barrier layer B-5 was formed by repeating an operation of spin-coating the coating liquid on the optically anisotropic layer which had been subjected to a plasma treatment with a plasma cleaner PDC-32G manufactured by Harrick Plasma Co., Ltd., and drying on a hot plate at 100° C. for 60 seconds, third times. A thickness of the formed oxygen barrier layer B-5 was 1.03 μm.

Coating liquid O-5 for oxygen barrier layer

| | | |
|---|---|---|
| EQUABARL (registered trademark) AQ-4104 | 4.00 | parts by mass |
| manufactured by Clariant | | |
| Isopropyl alcohol | 7.68 | parts by mass |
| Water | 88.32 | parts by mass |

### (5) Formation of Oxygen Barrier Layer B-6

The oxygen barrier layer B-6 was formed by further repeating the operation of spin-coating the coating liquid O-2 for an oxygen barrier layer to the oxygen barrier layer B-2 and drying the coating liquid on a hot plate at 100° C. for 60 seconds, two times. A thickness of the formed oxygen barrier layer B-6 was 3.12 μm.

### (6) Formation of Oxygen Barrier Layer B-7

An oxygen barrier layer was produced on the Z-TAC by repeating the operation of spin-coating the above-described coating liquid O-2 for an oxygen barrier layer onto a commercially available triacetyl cellulose film (manufactured by FUJIFILM Corporation, Z-TAC) and drying the coating film on a hot plate at 100° C. for 60 seconds, three times. The oxygen barrier layer on Z-TAC was bonded onto the optically anisotropic layer using a pressure sensitive adhesive SK2057 manufactured by Sanyo Chemical Industries, Ltd., and then the triacetyl cellulose film was peeled off to form an oxygen barrier layer B-7. A thickness of the formed oxygen barrier layer B-7 was 3.05 μm.

### (7) Formation of Oxygen Barrier Layer B-8

An oxygen barrier layer was produced on the Z-TAC by spin-coating the above-described coating liquid O-2 for an oxygen barrier layer onto a commercially available triacetyl cellulose film (manufactured by FUJIFILM Corporation, Z-TAC) and drying the coating film on a hot plate at 100° C. for 60 seconds. The glass and the alignment film P-1 were peeled off from the optically anisotropic layer, and the oxygen barrier layer on Z-TAC was bonded to the above-described peeled surface side of the optically anisotropic layer using a pressure sensitive adhesive SK2057 manufactured by SOKEN CHEMICAL CO., LTD., and then Z-TAC was peeled off to form an oxygen barrier layer B-8. A thickness of the formed oxygen barrier layer B-8 was 0.99 μm.

### [Bonding of Water Vapor Barrier Layer]

A Zeonor film (registered trademark) ZB12 manufactured by Zeon Corporation was bonded to the formed oxygen barrier layer using a pressure sensitive adhesive SK2057 manufactured by SOKEN CHEMICAL CO., LTD. as a water vapor barrier layer.

### <Measurement of Water Vapor Permeability>

The water vapor permeability of the water vapor barrier layer was measured by a cup method using a sample for measuring water vapor permeability with reference to JIS-Z-0208 (1976). Hereinafter, the details will be described.

First, a circular sample having a diameter of 70 mm was cut from the sample for measuring water vapor permeability. Next, 20 g of dried calcium chloride was put in a measurement cup, and covered with the circular sample, and accordingly, a lid-attached measurement cup was prepared. This lid-attached measurement cup was left in a constant-temperature and constant-humidity tank for 24 hours under the condition of 40° C. with 90% RH. The water vapor permeability of the circular sample (unit: g/(m²·day)) was calculated from a change in mass of the lid-attached measurement cup before and after the leaving. After performing the above measurement three times, an average value of the three measurements was calculated, and was defined as the water vapor permeability of the water vapor barrier layer.

The water vapor permeability of the Zeonor film (registered trademark) ZB12 manufactured by ZEON CORPORATION at 40° C. and 90% RH, which was obtained by the above-described measurement method, was 20 g/(m²·day) or less.

### [Production of Laminate]

Each laminate of Examples and Comparative Examples was produced based on the configuration shown in Table 1.

The configurations of the laminates of Examples and Comparative Examples are as follows.

### Laminates of Examples 1 to 9:

Oxygen barrier layer (lower side)/optically anisotropic layer/oxygen barrier layer (upper side)

### Laminate of Example 10:

Oxygen barrier layer (lower side)/optically anisotropic layer/oxygen barrier layer (upper side)/water vapor barrier layer (upper side)

### Laminates of Comparative Examples 1 to 3:

Oxygen barrier layer (lower side)/optically anisotropic layer

### [Various Measurements]

[Measurement of Oxygen Permeability Coefficient of Oxygen Barrier Layer, and the Like] The measurement of the oxygen permeability coefficient of the oxygen barrier layer was performed under the following conditions.

In a measurement of the oxygen permeability coefficient, the oxygen permeability coefficient of the oxygen barrier layer alone excluding B-1 (corresponding to glass) was determined by the following procedure.

An oxygen barrier layer was formed on the Z-TAC in accordance with “(6) Formation of oxygen barrier layer B-7” (the thickness of each oxygen barrier layer was the predetermined thickness described above (for example, 0.97 μm in a case of the oxygen barrier layer B-2)). Next, an oxygen permeability coefficient of the obtained Z-TAC with an oxygen barrier layer was determined by the following procedure. In addition, the oxygen permeability coefficient of the Z-TAC was obtained by the following procedure, and the oxygen permeability coefficient of the Z-TAC with an oxygen barrier layer was divided by the oxygen permeability coefficient of the Z-TAC to calculate the oxygen permeability coefficient of the oxygen barrier layer alone.
Test method: ISO 15105-2 (equal pressure method)
Tester: self-made oxygen permeability tester produced by partially modifying an oxygen concentration meter model 3600 manufactured by Hach Ultra Analytics, Inc. (weighing and calibration with an oxygen permeability tester OX-TRAN 2/10 type manufactured by AMETEK MOCON)
Test temperature: 25° C.
Test humidity: relative humidity of 50% RH
Test gas: air (oxygen content)

The measured oxygen permeability coefficient was evaluated based on the following evaluation standard.

### <Evaluation Standard>

“A”: oxygen permeability coefficient was 1.0×10⁻¹³ [cm³·cm/(cm²·s·mmHg)] or less
“B”: oxygen permeability coefficient was more than 1.0×10⁻¹³ [cm³·cm/(cm²·s·mmHg)] and 1.0×10⁻¹² [cm³·cm/(cm²·s·mmHg)] or less
“C”: oxygen permeability coefficient was more than 1.0×10⁻¹² [cm³·cm/(cm²·s·mmHg)]

In addition, a value obtained by dividing the measured oxygen permeability coefficient by the film thickness was evaluated based on the following evaluation standard.
“A”: a value obtained by dividing the oxygen permeability coefficient [cm³·cm/(cm²·s·mmHg)] by the film thickness [μm] was 1.0×10⁻¹³ or less.
“B”: a value obtained by dividing the oxygen permeability coefficient [cm³·cm/(cm²·s·mmHg)] by the film thickness [μm] was more than 1.0×10⁻¹³ and 1.0×10⁻¹² or less.
“C”: a value obtained by dividing the oxygen permeability coefficient [cm³·cm/(cm²·s·mmHg)] by the film thickness [μm] is more than 1.0×10⁻¹².

### [Calculation of ΔHSP]

The distance ΔHSP value was calculated by the following method.

(1) First, using the commercially available software “HSPiP”, three vectors of Hansen solubility parameter (dispersion element component of Hansen solubility parameter vector: δD, polar element component of Hansen solubility parameter vector: δP, and hydrogen bonding element component of Hansen solubility parameter vector: δH) were obtained for each of the main component constituting the oxygen barrier layer, the specific tolan compound, and the other liquid crystal compound.

For the oxygen barrier layer B-1, three vectors of Hansen solubility parameter were obtained for the main component constituting the oxygen barrier layer to SiO₂.

In addition, for the layers other than the oxygen barrier layer B-1, average δD, average SP, and average δH obtained from each δD, δP, and δH of the raw material monomer constituting the resin, and a mass fraction of each of the raw material monomers were regarded as δD, δP, and δH of the main component constituting the oxygen barrier layer.

(2) In a case where the liquid crystalline composition contained both the specific tolan compound and the other liquid crystal compound, the average δDₓ of the specific tolan compound and the other liquid crystal compound was calculated according to the following expression.

$$Average δ {D}_{x} = δ {D}_{1} \times {W}_{1} + δ {D}_{2} \times {W}_{2} + … δ {D}_{n} \times {W}_{n}$$

Here, δDₙ represents δD of each compound corresponding to the specific tolan compound and the other liquid crystal compound, and Wₙ represents a content of each compound (mass fraction: content ratio of each compound with respect to the total content of each compound) described above.

For example, in a case where the optically anisotropic layer contains the specific tolan compound and the other liquid crystal compound in equal amount to each, the average δDₓ=δD₁×W₁+δD₂×W₂ (δD₁ and δD₂ each represent δD of the specific tolan compound and the other liquid crystal compound, and W₁ and W₂ represent 0.5).

(3) According to the same procedure as in (2), the average δPₓ and the average δHₓ of the specific tolan compound and the other liquid crystal compound were each calculated.

(4) The distance ΔHSP was derived according to the following expression.

ΔHSP value=(4×(δD_{A}−δD_{B})²+(δP_{A}−δP_{B})²+(δH_{A}−δH_{B})²;^{0.5}

Here, in a case where the liquid crystalline composition contains both the specific tolan compound and the other liquid crystal compound, δD_{A}, δP_{A}, and δH_{A} each represent an average δDₓ, an average δPₓ, and an average δHₓ of the specific tolan compound and the other liquid crystal compound. In a case where the liquid crystalline composition contains only the specific tolan compound and does not contain other liquid crystal compounds, δD_{A}, δP_{A}, and δH_{A} each represent δD, δP, and δH of the specific tolan compound. In addition, δD_{B}, δP_{B}, and δH_{B} represent δD, δP, and δH of the main component constituting the oxygen barrier layer. The obtained ΔHSP was evaluated according to the following evaluation standard.

### <Evaluation Standard>

“A”: ΔHSP was 5.0 MPa^{0.5} or more.
“B”: ΔHSP was less than 5.0 MPa^{0.5}.

### (Transmittance Measurement)

The transmittance of the oxygen barrier layer was measured under the following conditions.

In a measurement of the transmittance, the transmittance of the oxygen barrier layer alone excluding B-1 (corresponding to glass) was determined by the following procedure.

An oxygen barrier layer was formed on the Z-TAC in accordance with “(6) Formation of oxygen barrier layer B-7” (the thickness of each oxygen barrier layer was the predetermined thickness described above (for example, 0.97 μm in a case of the oxygen barrier layer B-2)).

Next, a transmittance of the Z-TAC with the oxygen barrier layer was measured using a spectrophotometer UV-3100PC manufactured by Shimadzu Corporation. In addition, at that time, the transmittance of Z-TAC was separately measured and corrected, thereby calculating the average transmittance of visible light having a wavelength of 400 to 700 nm of the oxygen barrier layer alone. The measurement was performed in an environment of 25° C.

As a result of the above measurement, all of the transmittances of the oxygen barrier layers B-1 to B-8 were 80% or more.

### [Evaluation Results]

### [Measurement Method of Diffraction Efficiency]

An evaluation optical system in which a light source for evaluation, a polarizer, a ¼ wavelength plate, the optical element G (corresponding to each of the laminates of Examples and Comparative Examples), and a screen were arranged in this order was prepared. As the light source for evaluation, a laser pointer having a wavelength of 650 nm was used. As the 1/4 wave plate, SAQWP05M-700 manufactured by Thorlabs, Inc. was used. The slow axis of the ¼ wavelength plate was arranged at a relationship of 45° with respect to the absorption axis of the polarizer. In addition, the optical element G was arranged so that the lower oxygen barrier layer faced the light source side.

As a result of causing the light transmitted from the light source for evaluation through the polarizer and the ¼ wavelength plate, to be incident on the optical element G with being perpendicular to the film surface, a part of the light transmitted through the optical element was diffracted, and a plurality of bright spots could be confirmed on the screen.

The intensity of the diffracted light corresponding to each of the bright spots on the screen and the intensity of the zero-order light w measured with a power meter, and the diffraction efficiency was calculated according to the following expression.

Diffraction efficiency=(intensity of first-order light)/(intensity of zero-order light+intensity of diffracted light other than first-order light)

### [Evaluation of Light Resistance]

A light resistance test was performed on each produced optical element (corresponding to each of the laminates of Examples and Comparative Examples).

The produced optical element was irradiated with light using a super xenon weather meter SX75 manufactured by Suga Test Instruments Co., Ltd. As the UV cut filter, an ultraviolet absorbing filter SC-40 manufactured by FUJIFILM Corporation was used, and a light resistance test was performed by irradiating the filter with 5,000,000 lx of light for 72 hours. The temperature of the specimen to be tested (the temperature inside the test device) was set to 63° C. The relative humidity in the test device was 50% RH.

The diffraction efficiency at a point of 1 cm from an outer periphery of the optical element after the light resistance test in the center direction was measured, and the evaluation was performed based on the following evaluation standard. As the diffraction efficiency after the test is higher, the light resistance is more excellent. That is, it means that a high diffraction efficiency was exhibited by suppressing the photodegradation even after the test. The results are shown in Table 1.
“A”: the diffraction efficiency was 97% or more.
“B”: the diffraction efficiency was 95% or more and less than 97%.
“C”: the diffraction efficiency was 90% or more and less than 95%.
“D”: the diffraction efficiency was 80% or more and less than 90%.
“E”: the diffraction efficiency was less than 80%.

### [Evaluation of Durability]

A durability test was performed on each produced optical element (corresponding to each of the laminates of Examples and Comparative Examples).

The produced optical element was allowed to stand at 80° C. and a relative humidity of 50% RH for 500 hours, and a durability test was performed. The diffraction efficiency at a point of 1 cm from an outer periphery of the optical element after the durability test in the center direction was measured, and the evaluation was performed based on the following evaluation standard. As the diffraction efficiency after the test is higher, the durability is more excellent. That is, it means that a high diffraction efficiency was exhibited by suppressing the moist heat degradation even after the test. The results are shown in Table 1.
“A”: the diffraction efficiency was 98% or more.
“B”: the diffraction efficiency was 95% or more and less than 98%.
“C”: the diffraction efficiency was less than 95%

In Table 1, the column of “Direct bonding to optically anisotropic layer” indicates the disposition state of the optically anisotropic layer and the upper oxygen barrier layer (or lower oxygen barrier layer), and “No” indicates a case where the direct bonding is not performed (in other words, a case where another layer is interposed), and “Yes” indicates a case where the direct bonding is performed.

In Table 1, in the column of “Presence or absence of water vapor barrier layer”, “Absence” indicates that the water vapor barrier layer is not disposed, and “Presence” indicates that the water vapor barrier layer is disposed at a opposite surface to the optically anisotropic layer of the upper oxygen barrier layer.

TABLE 1

| | Configuration of laminate | | | | | | |
|---|---|---|---|---|---|---|---|
| | | Lower oxygen barrier layer | | | | | |
| | | | | Value | | | |
| | | | | obtained by | | | |
| | | | | dividing | | | |
| | | | | oxygen | Direct | | |
| | | | | permeability | bonding to | | |
| | Optically | | Oxygen | coefficient | optically | | Upper oxygen |
| | anisotropic | | permeability | by film | anisotropic | | barrier layer |
| | layer | Type | coefficient | thickness | layer | ΔHSP | Type |
| Comparative | H-1 | B-1 | A | A | No | A | Absence |
| Example 1 | | | | | | | |
| Example 1 | H-1 | B-1 | A | A | No | A | B-2 |
| Example 2 | H-1 | B-8 | B | B | No | A | B-2 |
| Example 3 | H-1 | B-8 | B | B | No | A | B-6 |
| Example 4 | H-1 | B-8 | B | B | No | A | B-7 |
| Comparative | H-2 | B-1 | A | A | No | — | Absence |
| Example 2 | | | | | | | |
| Example 5 | H-2 | B-1 | A | A | No | A | B-3 |
| Example 6 | H-2 | B-1 | A | A | No | A | B-4 |
| Example 7 | H-2 | B-1 | A | A | No | A | B-2 |
| Example 8 | H-2 | B-1 | A | A | No | A | B-6 |
| Example 9 | H-2 | B-1 | A | A | No | A | B-7 |
| Example 10 | H-2 | B-1 | A | A | No | A | B-2 |
| Example 11 | H-2 | B-8 | B | B | No | A | B-6 |
| Example 12 | H-2 | B-8 | B | B | No | A | B-7 |
| Comparative | H-3 | B-1 | A | A | No | — | Absence |
| Example 3 | | | | | | | |
| Example 13 | H-3 | B-1 | A | A | No | A | B-5 |

| | Configuration of laminate | | | | | | |
|---|---|---|---|---|---|---|---|
| | Upper oxygen barrier layer | | | | | | |
| | | Value | | | | | |
| | | obtained by | | | Presence | | |
| | | dividing | | | or | | |
| | | oxygen | Direct | | absence | | |
| | | permeability | bonding to | | of water | | |
| | Oxygen | coefficient | optically | | vapor | Evaluation result | |
| | permeability | by film | anisotropic | | barrier | Light | |
| | coefficient | thickness | layer | ΔHSP | layer | resistance | Durability |
| Comparative | — | — | — | — | Absence | E | — |
| Example 1 | | | | | | | |
| Example 1 | B | B | Yes | A | Absence | A | — |
| Example 2 | B | B | Yes | A | Absence | B | — |
| Example 3 | B | A | Yes | A | Absence | A | — |
| Example 4 | B | A | No | A | Absence | B | — |
| Comparative | — | — | — | — | Absence | E | C |
| Example 2 | | | | | | | |
| Example 5 | C | C | Yes | A | Absence | D | — |
| Example 6 | B | B | Yes | B | Absence | C | — |
| Example 7 | B | B | Yes | A | Absence | B | B |
| Example 8 | B | A | Yes | A | Absence | A | — |
| Example 9 | B | A | No | A | Absence | B | — |
| Example 10 | B | B | Yes | A | Presence | B | A |
| Example 11 | B | A | Yes | A | Absence | B | — |
| Example 12 | B | A | No | A | Absence | C | — |
| Comparative | — | — | — | — | Absence | E | — |
| Example 3 | | | | | | | |
| Example 13 | A | A | Yes | A | Absence | C | — |

From the results in Table 1, it was confirmed that, in the laminate of Examples, both the light resistance and the durability were excellent.

In addition, from the comparison of the examples, it was confirmed that, in a case where the oxygen permeability coefficient at 25° C. and 50% RH was 1.0×10⁻¹² [cm³·cm/(cm²·s·mmHg)] or less in both of the pair of oxygen barrier layers, the light resistance was further improved (see Example 5).

In addition, from the comparison of Examples, it was confirmed that, in a case where the distance ΔHSP value obtained from the predetermined expression was 5.0 MPa^{0.5} or more, the light resistance was further improved (see Examples 6 and the like).

In addition, from the comparison of Examples, it was confirmed that, in a case where the laminate further included a water vapor barrier layer having predetermined physical properties, the light resistance was further improved (see Example 10 and the like).

In addition, from the comparison of Examples, it was confirmed that, in a case where at least one of the oxygen barrier layers was disposed to be in direct contact with the optically anisotropic layer, the light resistance was further improved (see Example 4, Example 12, and the like).

On the other hand, in each of the laminates of Comparative Examples, the expected effect was not obtained.

### EXPLANATION OF REFERENCES

10: laminate
1, 2, 3: optically anisotropic layer
2A, 2B: oxygen barrier layer
4A, 4B: water vapor barrier layer
xy plane: sheet surface
z direction: thickness direction
30: liquid crystal compound
A: length of single period
30A: optical axis derived from liquid crystal compound 30
θ: angle
R: region
d: thickness (film thickness) of optically anisotropic layer
P_{L}: levorotatory circularly polarized light
P_{R}: dextrorotatory circularly polarized light
L₁, L₄, L₆: incidence light
L₂, L₅, L₇: transmitted light
Q¹, Q²: absolute phase
E¹, E²: equiphase surface
A₁, A₂, A₃: direction

What is claimed is:

1. A laminate comprising:
an optically anisotropic layer consisting of a cured layer of a composition containing a liquid crystal compound; and
a pair of oxygen barrier layers which are disposed on both sides of the optically anisotropic layer,
wherein the optically anisotropic layer has a liquid crystal alignment pattern in which an orientation of an optical axis derived from the liquid crystal compound is changed while continuously rotating along at least one in-plane direction,
the composition contains a compound having a partial structure represented by Formula (I),
the composition contains, as the liquid crystal compound, the compound having the partial structure represented by Formula (I), or the composition contains, as a compound which is not the liquid crystal compound, the compound having the partial structure represented by Formula (I), and
an oxygen permeability coefficient of the oxygen barrier layer at 25° C. and 50% RH is 1.0×10⁻¹¹ cm³·cm/(cm²·s·mmHg) or less, 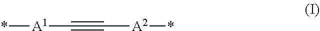
in Formula (I), A¹ and A² each independently represent an aromatic hydrocarbon ring group or an aromatic heterocyclic group, which may have a substituent, and * represents a bonding position.

2. The laminate according to claim 1,
wherein the composition contains, as the liquid crystal compound, the compound having the partial structure represented by Formula (I).

3. The laminate according to claim 2,
wherein the compound having the partial structure represented by Formula (I) is a polymerizable liquid crystal compound.

4. The laminate according to claim 2,
wherein the composition contains only the compound having the partial structure represented by Formula (I) as the liquid crystal compound, or
the composition further contains, as the liquid crystal compound, another liquid crystal compound having a structure different from a structure of the compound having the partial structure represented by Formula (I), and a content of the compound having the partial structure represented by Formula (I) is 50% by mass or more with respect to a total content of the compound having the partial structure represented by Formula (I) and the another liquid crystal compound.

5. The laminate according to claim 2,
wherein, in a case where the composition contains, as the liquid crystal compound, only the compound having the partial structure represented by Formula (I), a distance ΔHSP between a Hansen solubility parameter of a main component contained in the oxygen barrier layer and a Hansen solubility parameter of the compound having the partial structure represented by Formula (I), which is contained in the optically anisotropic layer, is larger than 3.5 MPa^{0.5}, and
in a case where the composition contains, as the liquid crystal compound, the compound having the partial structure represented by Formula (I) and another liquid crystal compound having a structure different from a structure of the compound having the partial structure represented by Formula (I), a distance ΔHSP between the Hansen solubility parameter of the main component contained in the oxygen barrier layer and an average Hansen solubility parameter of the compound having the partial structure represented by Formula (I) and the another liquid crystal compound, which are contained in the optically anisotropic layer, is larger than 3.5 MPa^{0.5}.

6. The laminate according to claim 5,
wherein at least one of the pair of oxygen barrier layers is disposed in direct contact with the optically anisotropic layer.

7. The laminate according to claim 1,
wherein the composition contains, as the compound which is not the liquid crystal compound, the compound having the partial structure represented by Formula (I), and further contains another liquid crystal compound having a structure different from a structure of the compound having the partial structure represented by Formula (I).

8. The laminate according to claim 7,
wherein a content of the compound having the partial structure represented by Formula (I) is 50% by mass or more with respect to a total content of the compound having the partial structure represented by Formula (I) and the another liquid crystal compound.

9. The laminate according to claim 7,
wherein a distance ΔHSP between a Hansen solubility parameter of a main component contained in the oxygen barrier layer and an average Hansen solubility parameter of the compound having the partial structure represented by Formula (I) and the another liquid crystal compound, which are contained in the optically anisotropic layer, is larger than 3.5 MPa^{0.5}.

10. The laminate according to claim 9,
wherein at least one of the pair of oxygen barrier layers is disposed in direct contact with the optically anisotropic layer.

11. The laminate according to claim 1,
wherein the compound having the partial structure represented by Formula (I) is a compound represented by Formula (II), 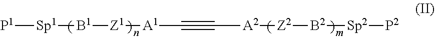
in Formula (II),
P¹ and P² each independently represent a hydrogen atom, a halogen atom, —CN, —NCS, or a polymerizable group,
Sp¹ and Sp² each independently represent a single bond or a divalent linking group, provided that Sp¹ and Sp² do not represent a divalent linking group including at least one group selected from the group consisting of an aromatic hydrocarbon ring group, an aromatic heterocyclic group, and an aliphatic hydrocarbon ring group,
Z¹ and Z² each independently represent a single bond or a divalent linking group, in a case where there are a plurality of Z¹'s and a plurality of Z²'s, the plurality of Z¹'s may be the same as or different from each other and the plurality of Z²'s may be the same as or different from each other, provided that Z¹ and Z² do not represent a divalent linking group including at least one group selected from the group consisting of an aromatic hydrocarbon group, an aromatic heterocyclic ring group, and an aliphatic hydrocarbon ring group,
A¹ and A² each independently represent an aromatic hydrocarbon ring group or an aromatic heterocyclic group, which may have a substituent,
B¹ and B² each independently represent an aromatic hydrocarbon ring group, an aromatic heterocyclic group, or an aliphatic hydrocarbon ring group, which may have a substituent, in a case where there are a plurality of B¹'s and a plurality of B²'s, the plurality of B¹'s may be the same as or different from each other and the plurality of B²'s may be the same as or different from each other, and
n and m each independently represent an integer in a range of 0 to 4.

12. The laminate according to claim 11,
wherein, in Formula (II), at least one of P¹ or P² is a polymerizable group.

13. The laminate according to claim 1,
wherein the compound having the partial structure represented by Formula (I) is a compound represented by Formula (III) or (IV), 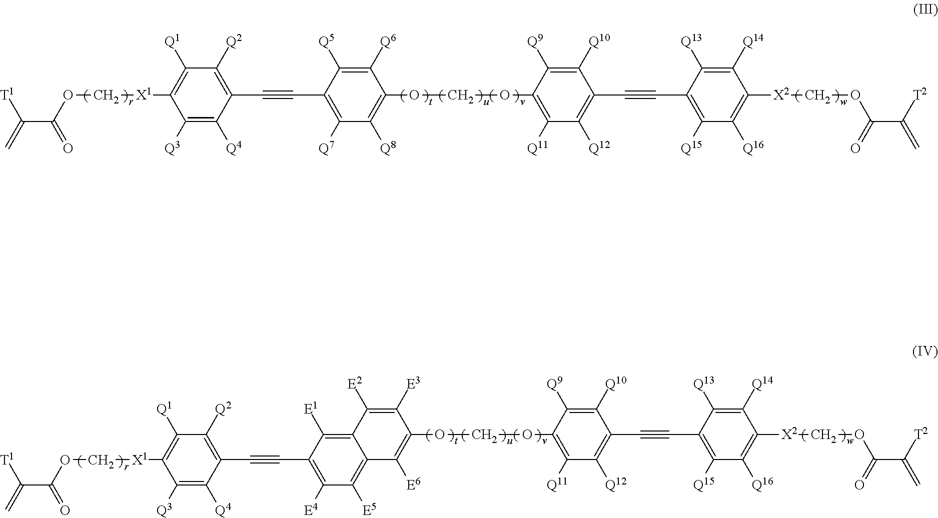
in Formulae (III) and (IV),
T¹ and T² each independently represent a hydrogen atom or a methyl group,
X¹ and X² each independently represent a methylene group, an oxygen atom, or a sulfur atom,
r represents an integer in a range of 1 to 5,
t and v each independently represent 0 or 1,
u represents 1 or 2,
w represents an integer in a range of 1 to 5,
Q¹ to Q¹⁶ each independently represent a hydrogen atom or a substituent, and
E¹ to E⁶ each independently represent a hydrogen atom or a substituent.

14. The laminate according to claim 1,
wherein Δn of the composition at a wavelength of 550 nm is 0.21 or more.

15. The laminate according to claim 1,
wherein in both of the pair of oxygen barrier layers, a value obtained by dividing the oxygen permeability coefficient [cm³·cm/(cm²·s·mmHg)] at 25° C. and 50% RH by a film thickness [μm] is 1.0×10⁻¹³ or less.

16. The laminate according to claim 1,
wherein in both of the pair of oxygen barrier layers, a transmittance is 70% or more.

17. The laminate according to claim 1,
wherein one of the pair of oxygen barrier layers is glass and the other is not glass.

18. The laminate according to claim 1, further comprising:
a water vapor barrier layer having a water vapor permeability of 100 g/(m²·day) or less at 40° C. and 90% RH,
wherein the water vapor barrier layer is disposed at a side of the oxygen barrier layer opposite to the optically anisotropic layer.

19. An optical element comprising:
the laminate according to claim 1.

20. A light guide element comprising:
the optical element according to claim 19; and
a light guide plate.
